(19) United States
(12) Patent Application Publication
(10) Pub. No.: US 2024/0171220 A1
(43) Pub. Date: May 23, 2024

(54) CHANNEL INFORMATION EXCHANGE FOR USER EQUIPMENT COOPERATION

(71) Applicant: QUALCOMM Incorporated, San Diego, CA (US)

(72) Inventors: Fang YUAN, Beijing (CN); Aleksandar DAMNJANOVIC, Del Mar, CA (US); Tao LUO, San Diego, CA (US); Xiaoxia ZHANG, San Diego, CA (US)

(21) Appl. No.: 18/549,345

(22) PCT Filed: May 27, 2021
(86) PCT No.: PCT/CN2021/096297

§ 371 Date: Sep. 6, 2023

(51) Int. Cl. H04B 7/026; H04W 72/23; H04W 88/04

(52) U.S. Cl. CPC H04B 7/026; H04W 72/23; H04W 88/04

(57) ABSTRACT

Methods, systems, and devices for wireless communications are described. In some examples, a wireless communications system may support user equipment (UE) cooperation. When a first UE and second UE are in a cooperative configuration, a base station may use the first UE to request and obtain channel information for the second UE. For example, the base station may transmit a request for channel information to the first UE and the first UE may relay the request to the second UE. The second UE may determine the channel information and transmit a report including the channel information to the first UE, where the first UE may relay the report to the base station. In some examples, the report, the request, or both may be exchanged between devices using medium access control control element (MAC-CE)-based methods or using downlink control information (DCI)-based methods. The DCI-based methods may involve relaxed timings.

### CROSS REFERENCE

The present Application is a 371 national stage filing of International PCT Application No. PCT/CN2021/096297 by YUAN et al. entitled “CHANNEL INFORMATION EXCHANGE FOR USER EQUIPMENT COOPERATION,” filed May 27, 2021, which is assigned to the assignee hereof, and which is expressly incorporated by reference in its entirety herein.

### FIELD OF TECHNOLOGY

The following relates to wireless communications, including channel information exchange for user equipment (UE) coop-eration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a wireless communications system may support UE cooperation. During UE cooperation, a set of UEs may act as a single virtual UE. That is, the UEs may collectively receive and transmit the same information to the network. In some examples, a UE of the set (e.g., a target UE) may act as a relay and transmit information to the network that it receives from another UE of the set (e.g., a cooperative UE). But the methods in which information is exchanged between the network and a UE using another UE as relay in UE cooperation may be unreliable.

### SUMMARY

The described techniques relate to improved methods, systems, devices, and apparatuses that support channel information exchange for user equipment (UE) cooperation. Generally, the described techniques provide for a target UE to transmit information related to a cooperative UE to the network, where the target UE and the cooperative UE may be in a cooperative configuration (e.g., operating jointly such that they are jointly perceived as being a single UE by the network, which may be referred to as operating as a virtual UE, or as being configured or otherwise operating in UE cooperation).

In some examples, the network may transmit a request for channel information associated with the cooperative UE (e.g., associated with a channel between the cooperative UE and the network) to the target UE, and the target UE may forward the request to the cooperative UE. The cooperative UE may then generate a report including the channel information and transmit the report to the target UE, where the target UE may forward the report to the network. In one example, the request or the report may be exchanged between devices (e.g., between the base station and the target UE or between the target UE and the cooperative UE) via a medium access control control element (MAC-CE). In another example, the request or the report may be exchanged between the devices (e.g., between the base station and the target UE or between the target UE and the cooperative UE) using downlink control information (DCI)-based methods with relaxed timings.

A method is described. The method may include receiving, from a first transmission and reception point (TRP) via a first communication link, a request for channel information associated with a second communication link between a second UE and a second TRP, relaying, to the second UE via a third communication link, the request for the channel information associated with the second communication link, receiving, from the second UE via the third communication link, a report including the channel information associated with the second communication link, and relaying, to the first TRP via the first communication link, the report including the channel information associated with the second communication link.

An apparatus is described. The apparatus may include a processor, memory coupled with the processor, and instructions stored in the memory. The instructions may be executable by the processor to cause the apparatus to receive, from a first TRP via a first communication link, a request for channel information associated with a second communication link between a second UE and a second TRP, relay, to the second UE via a third communication link, the request for the channel information associated with the second communication link, receive, from the second UE via the third communication link, a report including the channel information associated with the second communication link, and relay, to the first TRP via the first communication link, the report including the channel information associated with the second communication link.

Another apparatus is described. The apparatus may include means for receiving, from a first TRP via a first communication link, a request for channel information associated with a second communication link between a second UE and a second TRP, means for relaying, to the second UE via a third communication link, the request for the channel information associated with the second communication link, means for receiving, from the second UE via the third communication link, a report including the channel information associated with the second communication link, and means for relaying, to the first TRP via the first communication link, the report including the channel information associated with the second communication link.

A non-transitory computer-readable medium storing code is described. The code may include instructions executable by a processor to receive, from a first TRP via a first communication link, a request for channel information associated with a second communication link between a second UE and a second TRP, relay, to the second UE via a third communication link, the request for the channel information associated with the second communication link, receive, from the second UE via the third communication link, a report including the channel information associated with the second communication link, and relay, to the first TRP via the first communication link, the report including the channel information associated with the second communication link.

In some examples of the method, apparatuses, and non-transitory computer-readable medium described herein, receiving the request for the channel information associated with the second communication link may include operations, features, means, or instructions for receiving a MAC-CE, the MAC-CE including the request for the channel information associated with the second communication link.

In some examples of the method, apparatuses, and non-transitory computer-readable medium described herein, relaying the request for the channel information associated with the second communication link may include operations, features, means, or instructions for transmitting a MAC-CE via the third communication link, the MAC-CE including information based on the request received via the first communication link.

In some examples of the method, apparatuses, and non-transitory computer-readable medium described herein, receiving the report including the channel information associated with the second communication link may include operations, features, means, or instructions for receiving a MAC-CE, the MAC-CE including the report including the channel information associated with the second communication link.

In some examples of the method, apparatuses, and non-transitory computer-readable medium described herein, relaying the report including the channel information associated with the second communication link may include operations, features, means, or instructions for transmitting a MAC-CE via the first communication link, the MAC-CE including information based on the report received via the third communication link.

In some examples of the method, apparatuses, and non-transitory computer-readable medium described herein, receiving the request for the channel information associated with the second communication link may include operations, features, means, or instructions for receiving DCI, the DCI including the request for the channel information associated with the second communication link.

In some examples of the method, apparatuses, and non-transitory computer-readable medium described herein, relaying the request for the channel information associated with the second communication link may include operations, features, means, or instructions for transmitting, via the third communication link, information based on the DCI received via the first communication link.

Some examples of the method, apparatuses, and non-transitory computer-readable medium described herein may further include operations, features, means, or instructions for relaying, to the second UE via the third communication link, the request for the channel information associated with the second communication link occurs a first duration after the first UE receives the request from the first TRP.

In some examples of the method, apparatuses, and non-transitory computer-readable medium described herein, at least one of the request for the channel information or the report including the channel information includes a UE identity (ID), a panel ID, or a component carrier (CC) ID, or any combination thereof associated with the second UE.

In some examples of the method, apparatuses, and non-transitory computer-readable medium described herein, the request for the channel information includes a channel state information (CSI) request ID, a CSI measurement ID, a CSI reference signal (CSI-RS) resource set ID, or a CSI report setting ID.

In some examples of the method, apparatuses, and non-transitory computer-readable medium described herein, at least one of the request for the channel information or the report including the channel information includes an indication of one or more time resources associated with a reference signal for the second communication link or one or more time resources associated with the report.

Some examples of the method, apparatuses, and non-transitory computer-readable medium described herein may further include operations, features, means, or instructions for monitoring for a second request for the channel information associated with the second communication link after relaying the report including the channel information associated with the second communication link.

In some examples of the method, apparatuses, and non-transitory computer-readable medium described herein, the report including the channel information includes a periodic CSI report or an aperiodic CSI report.

In some examples of the method, apparatuses, and non-transitory computer-readable medium described herein, the first communication link may be associated with a first communication protocol and the third communication link may be associated with a second communication protocol.

A method is described. The method may include receiving, from a first UE via a third communication link, a request for channel information associated with a second communication link between the second UE and a second TRP, the first UE in communication with a first TRP via a first communication link, receiving, from the second TRP via the second communication link, one or more reference signals, generating a report including the channel information based on the request and the one or more reference signals, and transmitting, to the first UE via the third communication link, the report including the channel information.

An apparatus is described. The apparatus may include a processor, memory coupled with the processor, and instructions stored in the memory. The instructions may be executable by the processor to cause the apparatus to receive, from a first UE via a third communication link, a request for channel information associated with a second communication link between the second UE and a second TRP, the first UE in communication with a first TRP via a first communication link, receive, from the second TRP via the second communication link, one or more reference signals, generate a report including the channel information based on the request and the one or more reference signals, and transmit, to the first UE via the third communication link, the report including the channel information.

Another apparatus is described. The apparatus may include means for receiving, from a first UE via a third communication link, a request for channel information associated with a second communication link between the second UE and a second TRP, the first UE in communication with a first TRP via a first communication link, means for receiving, from the second TRP via the second communication link, one or more reference signals, means for generating a report including the channel information based on the request and the one or more reference signals, and means for transmitting, to the first UE via the third communication link, the report including the channel information.

A non-transitory computer-readable medium storing code is described. The code may include instructions executable by a processor to receive, from a first UE via a third communication link, a request for channel information associated with a second communication link between the second UE and a second TRP, the first UE in communication with a first TRP via a first communication link, receive, from the second TRP via the second communication link, one or more reference signals, generate a report including the channel information based on the request and the one or more reference signals, and transmit, to the first UE via the third communication link, the report including the channel information.

In some examples of the method, apparatuses, and non-transitory computer-readable medium described herein, receiving the request for the channel information associated with the second communication link may include operations, features, means, or instructions for receiving a MAC-CE, the MAC-CE including the request for the channel information associated with the second communication link.

In some examples of the method, apparatuses, and non-transitory computer-readable medium described herein, transmitting the report including the channel information associated with the second communication link may include operations, features, means, or instructions for transmitting a MAC-CE, the MAC-CE including the report including the channel information associated with the second communication link.

In some examples of the method, apparatuses, and non-transitory computer-readable medium described herein, receiving the request for the channel information associated with the second communication link may include operations, features, means, or instructions for receiving, via the third communication link, information based on DCI associated with the first communication link.

Some examples of the method, apparatuses, and non-transitory computer-readable medium described herein may further include operations, features, means, or instructions for transmitting, to the first UE via the first communication link, the report including the channel information associated with the second communication link occurs a first duration after the second UE receives the one or more reference signals.

In some examples of the method, apparatuses, and non-transitory computer-readable medium described herein, at least one of the request for the channel information and the report including the channel information includes a UE ID, a panel ID, or a CC ID, or any combination thereof associated with the second UE.

In some examples of the method, apparatuses, and non-transitory computer-readable medium described herein, the request for the channel information includes a CSI request ID, a CSI measurement ID, a CSI-RS resource set ID, or a CSI report setting ID.

In some examples of the method, apparatuses, and non-transitory computer-readable medium described herein, at least one of the request for the channel information or the report includes the channel information includes an indication of one or more time resources associated with the one or more reference signals or one or more time resources associated with the report.

Some examples of the method, apparatuses, and non-transitory computer-readable medium described herein may further include operations, features, means, or instructions for monitoring for a second request for channel information associated with the second communication link after transmitting the report including the channel information associated with the second communication link.

In some examples of the method, apparatuses, and non-transitory computer-readable medium described herein, the report including the channel information includes a periodic CSI report or an aperiodic CSI report.

Some examples of the method, apparatuses, and non-transitory computer-readable medium described herein may further include operations, features, means, or instructions for detecting a radio link failure (RLF) associated with the second communication link, where receiving the request for the channel information associated with the second communication link may be based on detecting the RLF associated with the second communication link.

Some examples of the method, apparatuses, and non-transitory computer-readable medium described herein may further include operations, features, means, or instructions for transmitting, to the first UE, signaling indicating the RLF associated with the second communication link, where receiving the request for the channel information associated with the second communication link may be based at least in part on transmitting the signaling.

A method is described. The method may include establishing a first communication link with a first UE, transmitting, to the first UE via the first communication link, a request for channel information associated with a second communication link between a second UE and the base station, and receiving, from the first UE via the first communication link, the report including the channel information associated with the second communication link.

An apparatus is described. The apparatus may include a processor, memory coupled with the processor, and instructions stored in the memory. The instructions may be executable by the processor to cause the apparatus to establish a first communication link with a first UE, transmit, to the first UE via the first communication link, a request for channel information associated with a second communication link between a second UE and the base station, and receive, from the first UE via the first communication link, the report including the channel information associated with the second communication link.

Another apparatus is described. The apparatus may include means for establishing a first communication link with a first UE, means for transmitting, to the first UE via the first communication link, a request for channel information associated with a second communication link between a second UE and the base station, and means for receiving, from the first UE via the first communication link, the report including the channel information associated with the second communication link.

A non-transitory computer-readable medium storing code is described. The code may include instructions executable by a processor to establish a first communication link with a first UE, transmit, to the first UE via the first communication link, a request for channel information associated with a second communication link between a second UE and the base station, and receive, from the first UE via the first communication link, the report including the channel information associated with the second communication link.

Some examples of the method, apparatuses, and non-transitory computer-readable medium described herein may further include operations, features, means, or instructions for transmitting the request for the channel information associated with the second communication link includes transmitting a MAC-CE, the MAC-CE including the request for the channel information associated with the second communication link and receiving the report including the channel information associated with the second communication link includes receiving a MAC-CE, the MAC-CE including the report including the channel information associated with the second communication link.

### BRIEF DESCRIPTION OF THE DRAWINGS

FIGS. 1-3 illustrate examples of a wireless communications system that supports channel information exchange for UE cooperation in accordance with aspects of the present disclosure.

FIGS. 4 and 5 illustrate examples of a process flow that supports channel information exchange for UE cooperation in accordance with aspects of the present disclosure.

FIGS. 6 and 7 show block diagrams of devices that support channel information exchange for UE cooperation in accordance with aspects of the present disclosure.

FIG. 8 shows a block diagram of a communications manager that supports channel information exchange for UE cooperation in accordance with aspects of the present disclosure.

FIG. 9 shows a diagram of a system including a device that supports channel information exchange for UE cooperation in accordance with aspects of the present disclosure.

FIGS. 10 and 11 show block diagrams of devices that support channel information exchange for UE cooperation in accordance with aspects of the present disclosure.

FIG. 12 shows a block diagram of a communications manager that supports channel information exchange for UE cooperation in accordance with aspects of the present disclosure.

FIG. 13 shows a diagram of a system including a device that supports channel information exchange for UE cooperation in accordance with aspects of the present disclosure.

FIGS. 14 through 18 show flowcharts illustrating methods that support channel information exchange for UE cooperation in accordance with aspects of the present disclosure.

### DETAILED DESCRIPTION

In some examples, a wireless communications system may support user equipment (UE) cooperation. In UE cooperation, a set of UEs may act as a single virtual UE. That is, the set of UE may collectively receive different aspects of information from the network and exchange these different aspects amongst each other. The set of UEs may include at least one target UE and one cooperative UE. In some examples, the network may utilize a target UE to retrieve information from a cooperative UE. That is, the target UE may function as a relay UE, retrieving information from the cooperative UE and transmitting the information to the network. In some examples, to support UE cooperation, a base station may include multiple transmission and reception points (TRPs). For example, the base station may include a first TRP and a second TRP. The first TRP may establish a link with the target UE and the second TRP may establish a link with the cooperative UE. As used herein, references to a wireless device (e.g., a target UE) relaying or forwarding a message may refer to the wireless device transmitting signaling representative of information included in the message to a second wireless device (e.g., a cooperative UE, or a base station), though such signaling may in some cases be in the form of a second message of a different type than the initial message (e.g., the second message may be in accordance with a different communications protocol, may be transmitted via a different type of physical channel, may be encoded differently, or the like) or that includes some information in addition to the relayed or forwarded information.

In some examples, the target UE and the cooperative UE may be separately scheduled. That is, the target UE and the cooperative UE may receive downlink control information (DCI) including scheduling information directly from their respective TRPs as opposed to receiving DCI or DCI-related information including scheduling information from one another. Self-scheduled UEs may not support the exchanging of DCI or DCI-related information with one another and instead, may support simpler modes of communication exchange (e.g., transport block (TB) exchange). But, in some examples, a UE and a respective TRP may experience a radio link failure (RLF) (e.g., beam failure). For example, the cooperative UE and the second TRP may experience a RLF. During the RLF, the cooperative UE may be unable to receive DCI from the second TRP and, as such, the network may be unable to trigger channel state information (CSI) reporting at the cooperative UE. Without CSI reporting, the cooperative UE may be unable to recover from the beam failure or beam failure recovery (BFR) may be inefficient.

In some examples, the network may trigger CSI reporting at a cooperative UE using cross-UE medium access control (MAC) control element (MAC-CE) exchange. In some examples, a self-scheduled UE that supports TB exchange may also support MAC-CE exchange. The first TRP may transmit a MAC-CE to the target UE including a CSI request requesting a CSI report associated with the link between the cooperative UE and the second TRP. In response, the target UE may relay the CSI request to the cooperative UE via a MAC-CE. The cooperative UE may receive the CSI request and generate a CSI report according to the CSI request. The cooperative UE may then transmit a MAC-CE to the target UE including the CSI report and the target UE may relay the CSI report to the first TRP via a MAC-CE. In some examples, at least one of the CSI request or the CSI report may include a UE identity (ID), a CSI request ID, or timing aspects related to the CSI report. Using such techniques may allow for the network to trigger CSI reporting at a cooperative UE in situations where the target UE and the cooperative UE may not support the exchange of DCI or DCI-related information.

In another example, the network may trigger CSI reporting at a cooperative UE using cross-UE DCI or DCI-related information exchange with relaxed CSI timings. The target UE may receive DCI from the first TRP including a CSI request requesting a CSI report associated with a link between the second TRP and the second UE and relay the CSI request to the cooperative UE (e.g., using decoded bits of the DCI) after a first timing offset. The target UE may receive the request, generate the CSI report, and transmit the CSI report to the target UE after a second timing offset. In some example, the network may preconfigure the target UE and the cooperative UE with the first timing offset and the second timing offset (e.g., via radio resource control (RRC) signaling). In some examples, at least one of the CSI request or the CSI report may include a UE ID, a CSI request ID, or timing aspects related to the CSI report.

Aspects of the disclosure are initially described in the context of wireless communications systems. Additional aspect are described in the context of process flows. Aspects of the disclosure are further illustrated by and described with reference to apparatus diagrams, system diagrams, and flowcharts that relate to channel information exchange for UE cooperation.

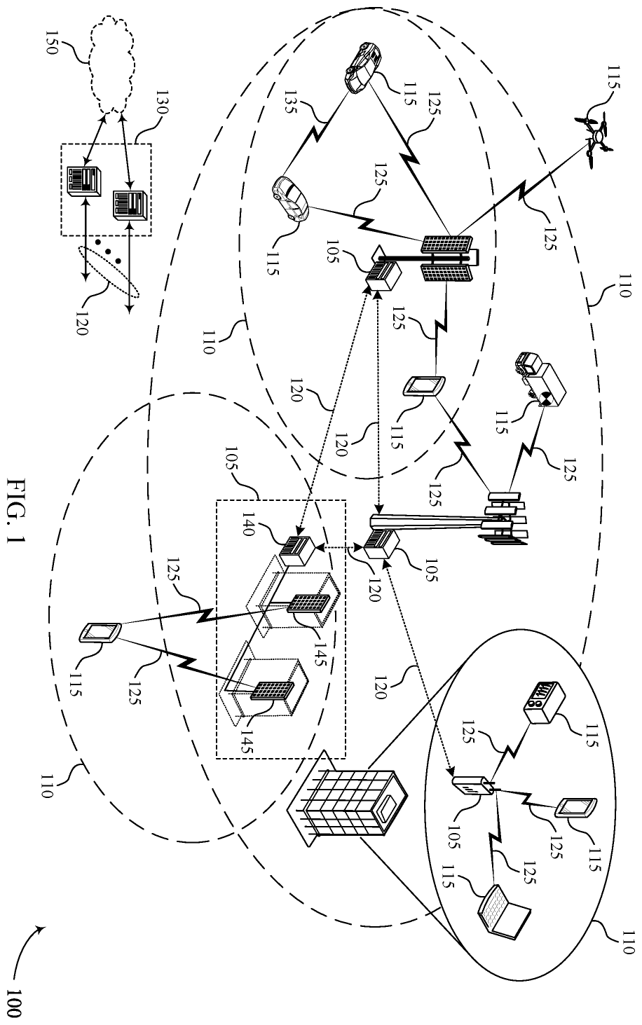

FIG. 1 illustrates an example of a wireless communications system 100 that supports channel information exchange for UE cooperation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CCs) and one or more uplink CCs according to a carrier aggregation configuration. Carrier aggregation may be used with both frequency division duplexing (FDD) and time division duplexing (TDD) CCs.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with CCs operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

In some examples, during UE cooperation, the network may instruct a target UE 115 to retrieve information from a cooperative UE 115. For example, the network may transmit a request for channel information associated with the cooperative UE to the target UE and the target UE may forward the request to the cooperative UE. The cooperative UE may then generate a report including the channel information and transmit the report to the target UE, where the target UE may forward the report to the network. In one example, the request or the report may be exchanged between devices (e.g., between the base station and the target UE or between the target UE and the cooperative UE) via a MAC-CE. In another example, the request or the report may be exchanged between the devices (e.g., between the base station and the target UE or between the target UE and the cooperative UE) using DCI-based methods with relaxed timings.

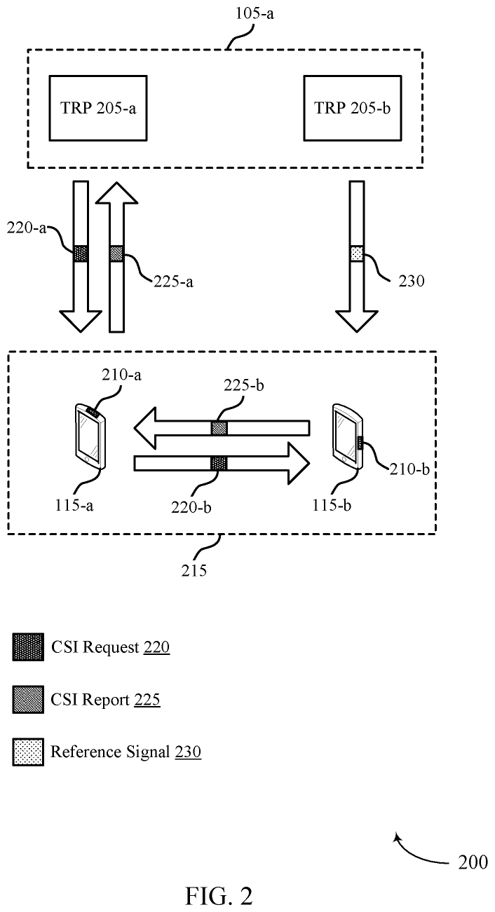

FIG. 2 illustrates an example of a wireless communications system 200 that supports channel information exchange for UE cooperation in accordance with aspects of the present disclosure. In some examples, the wireless communications system 200 may implement aspects of a wireless communications system 100. For example, the wireless communications system 200 may include a base station 105-a, a UE 115-a, and a UE 115-b which may be examples of a base station 105 and a UE 115 as described with reference to FIG. 1.

In some examples, the wireless communications system 200 may support UE cooperation. In UE cooperation, a set of panels 210 may be distributed across a set of UEs 115 as opposed to being localized at a single UE 115. For example, the UE 115-a and the UE 115-b may be an example of the set of UEs 115, where the UE 115-a may include a panel 210-a and the UE 115-b may include a panel 210-b. During UE cooperation, the network may perceive the set of UEs 115 (e.g., the UE 115-a and the UE 115-b) as a single virtual UE 215. As such, the UE 115-a and the UE 115-b may jointly transmit information to a base station 105-a and jointly receive information from the base station 105-a. In some examples, the set of UEs 115 may include at least one target UE and at least one cooperative UE. The target UE may be a UE 115 for which data is meant to be communicated with the base station 105-a and the cooperative UE may be a UE 115 that cooperates with the target UE to aid in the transmission and reception of the data to and from the base station 105-a. In some examples, the set of UEs 115 (e.g., the UE 115-a and the UE 115-b) may operate on the same CC. Alternatively, the set of UEs 115 (e.g., the UE 115-a and the UE 115-b) may operate on different CCs.

In some examples, to support UE cooperation, the base station 105-a may include multiple TRPs 205. For example, the base station 105-a may include a TRP 205-a and a TRP 205-b. The TRP 205-a may establish a communication link (e.g., Uu link) with the UE 115-a and the TRP 205-b may establish a communication link with the UE 115-b (e.g., Uu link). In addition to communicating with the base station 105-a, the set of UEs 115 may cooperate with one another over sidelink communication links. In some examples, the communication links and the sidelink communication links may be associated with different communication protocols. For example, TRPs 205 may communicate with respective UEs 115 using cellular-based communication (e.g., LTE NR, etc.) and the UEs 115 may communicate with each other using Wi-Fi-based communication or other types of communication protocols (e.g., proprietary protocols). In other examples, the communications links and the sidelink communication link may be associated with the same communication protocol.

The set of UEs 115 may receive scheduling information from the network using various different methods. For example, two potential methods may be described as self-scheduling and cross-scheduling. UEs 115 that support self-scheduling may receive scheduling information via DCI directly from a respective TRP 205. For example, the UE 115-a may receive first DCI including scheduling information from the TRP 205-a and the UE 115-b may receive second DCI including scheduling information from the TRP 205-b. In some examples, self-scheduled UEs 115 may support transport block (TB) exchange between one another over sidelink, but may not support DCI or DCI-related information exchange between one another over sidelink. UEs 115 that support cross-scheduling may receive their scheduling information from another UE 115 (as opposed to receiving scheduling information directly from a respective TRP 205). In such example, the UE 115-a (e.g., the target UE) may receive scheduling information associated with the UE 115-a via a first DCI and scheduling information associated with the UE 115-b (e.g., the cooperative UE) via a second DCI from the TRP 205-a. Upon receiving the first and second DCI, the UE 115-a may forward the scheduling information associated with the UE 115-b to the UE 115-b over sidelink. Forwarding the scheduling information associated with the UE 115-b may include forwarding decoded bits of the second DCI or quadrature signals (e.g., in-phase/quadrature (I/Q) samples or other forms of IQ data or IQ signaling) based on the second DCI, the forwarded information including the scheduling information associated with the UE 115-b to the UE 115-b. As opposed to self-scheduled UEs 115, cross-scheduled UEs 115 may support DCI or DCI-related information exchange between one another as well as TB exchange between one another.

In some examples, the network may determine that an uplink transmission from the UE 115 to the TRP 205 is poor in terms of signal quality or strength. For example, the network may determine that the signal quality or strength of an uplink transmission between the UE 115-b (e.g., cooperative UE) and the TRP 205-b is below a threshold. Based on this determination, the network may trigger aperiodic CSI reporting at the UE 115-b. A CSI report 225 may contain information such as a channel quality indicator (CQI), a precoding matrix indicator (PMI), a rank indicator (RI), etc. To trigger aperiodic CSI reporting at the UE 115-b, the network may transmit DCI including an aperiodic CSI request 220 to the UE 115-b. The aperiodic CSI request 220 may request for a CSI report 225 associated with the communication link between the UE 115-b and the TRP 205-b to be sent to the network and may include information related to generating the aperiodic CSI report 225. Upon receiving the DCI, the UE 115-b may measure one or more reference signals 230 (e.g., one or more CSI-RSs) received from the TRP 205-b, generate the CSI report 225 according to the CSI request 220, and transmit the CSI report 225 to the network. If the UE 115-b supports self-scheduling, the UE 115-b may receive the DCI including the CSI request 220 directly from the TRP 205-b. If the UE 115-b supports cross-scheduling, the UE 115-b may receive decoded bits or I/Q samples of the DCI including the CSI request 220 from the UE 115-a and may transmit the CSI report 225 to the UE 115-a. The UE 115-a may then forward the CSI report 225 to the TRP 205-a.

In some examples, a communication link between a cooperating UE 115 and a respective TRP 205 may fail completely. For example, the UE 115-b and the TRP 205-b may experience a beam failure. During the beam failure, the UE 115-b and the TRP 205-b may be unable to exchange control information with one another. That is, the TRP 205-b may be unable to transmit DCI to the UE 115-b. Because a self-scheduled UE 115 may utilize DCI from the TRP 205-b to trigger aperiodic CSI reporting, the UE 115 may be unable to provide CSI reports 225 to the network during a beam failure. In some examples, the inability of the UE 115-b to construct and provide CSI reports 225 to the network may negatively impact how quickly the UE 115-b recovers from the beam failure.

As described herein, a UE 115 may utilize MAC-CE exchange for CSI reporting during UE cooperation. In some examples, the network may request to receive channel information associated with a communication link between a UE 115 and a TRP 205 (e.g., if the network determines that an uplink transmission from the UE 115 to the TRP 205 is poor or if a beam failure occurs between the UE 115 and the TRP 205). For example, the network may request to receive channel information associated with the communication link between the UE 115-b and the TRP 205-b. To request to receive channel information associated with the communication link between the UE 115-b and the TRP 205-b, the TRP 205-a may transmit a MAC-CE carrying a CSI request 220-a to the UE 115-a. The CSI request 220-a may request for a CSI report 225 associated with the communication link between the UE 115-b and the TRP 205-b to be sent to the network and may include information related to generating the aperiodic CSI report 225. Upon receiving the MAC-CE from the TRP 205-a, the UE 115-a may transmit a MAC-CE carrying a CSI request 220-b to the UE 115-b. In some examples, the CSI request 220-a and the CSI request 220-b may include the same information. That is, the UE 115-a may forward the CSI request 220-a received from the TRP 205-a to the UE 115-b. Upon receiving the CSI request 220-b from the UE 115-a, the UE 115-b may generate a CSI report 225-a and transmit the CSI report 225-a to the UE 115-a via a MAC-CE. The CSI report 225-a may include channel information associated with the link between the TRP 205-b and the UE 115-b (e.g., CQI, PMI, etc.). In some examples, the UE 115-a may then transmit a CSI report 225-b to the TRP 205-b via a MAC-CE. In some examples, the CSI report 225-a and the CSI report 225-b may include the same information. That is, the UE 115-a may forward the CSI report 225-b received from the UE 115-b to the TRP 205-a.

In some examples, one or both of the CSI request 220 or the CSI report 225 may include some indication of the UE 115 for which the channel information is requested of. For example, the CSI request 220 or the CSI report 225 may include a UE ID, a panel ID, or a CC ID associated with the UE 115-b. Additionally or alternatively, the MAC-CE carrying the CSI requests 220 may include a CSI request ID. The CSI request ID may help to distinguish the CSI request 220 (e.g., CSI request 220-a or CSI request 220-b) from other CSI requests 220 intended for the same UE 115 (e.g., the UE 115-b). In some examples, the MAC-CE carrying the CSI requests 220 may also include information for constructing the CSI report 225. For example, the MAC-CE carrying the CSI request may include a CSI measurement ID, a CSI-RS resource set ID, or a CSI report setting ID. Additionally or alternatively, one or both of the CSI request 220 and the CSI report 225 may include timing indicators. For example, the CSI request 220 may include a timing indicator indicating the timing of the one or more reference signals 230 to be measured by the UE 115-b or a timing indicator indicating the timing of the CSI report 225. The methods as described herein may allow for CSI triggering across UEs in UE cooperation even if the UEs do not support DCI exchange (e.g., self-scheduled UEs) and in the event of a beam failure.

In another example, a UE 115 may utilize DCI-exchange with relaxed timing for CSI reporting. In some examples, the UEs 115 (e.g., a UE 115-a and a UE 115-b) may be preconfigured by the network with two or more timing offsets. For example, the UE 115-a and the UE 115-b may be preconfigured with a first timing offset and a second timing offset. The first timing offset may define a delay between receiving a CSI request 220 at a UE 115 and forwarding the CSI request 220 to another UE 115 and the second timing offset may define a delay between generating the CSI report 225 at a UE 115 and transmitting the CSI report 225 to another UE 115. In some examples, the network may request to receive channel information associated with the communication link between the UE 115-b and the TRP 205-b. To request to receive channel information associated with the communication link between the UE 115-b and the TRP 205-b, the TRP 205-a may transmit DCI carrying a CSI request 220-a associated with the UE 115-b to the UE 115-a. Upon receiving the CSI request 220-a from the TRP 205-b, the UE 115-a may apply the first timing offset. That is, the UE 115-a may delay transmitting decoded bits or I/Q samples of the DCI to the UE 115-b according to the first timing offset. Upon receiving the decoded bits or I/Q samples of the DCI from the UE 115-a, the UE 115-b may generate a CSI report 225-b and apply the second timing offset. That is, the UE 115-b may delay transmitting the CSI report 225-b to the UE 115-b according to the second timing offset. Upon receiving, the CSI report 225-b from the UE 115-b, the UE 115-a may transmit the CSI report 225-a to the TRP 205-a. In some examples, the CSI report 225-a and the CSI report 225-b may include the same information. That is, the UE 115-a may forward the CSI report 225-b received from the UE 115-b to the TRP 205-b.

In some examples, one or both of the CSI request 220 or the CSI report 225 may include some indication of the UE 115 for which the channel information is requested of. For example, the CSI request 220 or the CSI report 225 may include a UE ID, a panel ID, or a CC ID associated with the UE 115-b. Additionally or alternatively, the DCI carrying the CSI request 220 may include a CSI request ID. The CSI request ID may help to distinguish the CSI request 220 (e.g., CSI request 220-a or CSI request 220-b) from other CSI requests 220 intended for the same UE 115 (e.g., the UE 115-b). In some examples, the DCI carrying the CSI request 220 may also include information for constructing the CSI report 225. For example, the DCI carrying the CSI request may include a CSI measurement ID, a CSI-RS resource set ID, or a CSI report setting ID. Additionally or alternatively, one or both of the CSI request 220 and the CSI report 225 may include timing indicators. For example, the CSI request 220 may include a timing indicator indicating the timing of the one or more reference signals 230 to be measured by the UE 115-b or a timing indicator indicating the timing of the CSI report 225. The methods as described herein may allow for CSI triggering across UEs in UE cooperation using DCI exchange (e.g., self-scheduling UEs) and in the event of a beam failure.

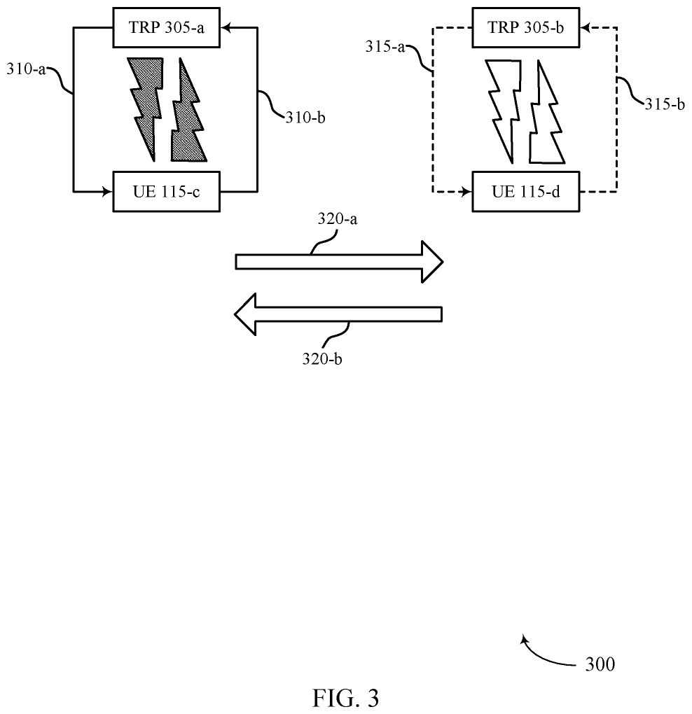

FIG. 3 illustrates an example of a wireless communications system 300 that supports channel information exchange for UE cooperation in accordance with aspects of the present disclosure. In some examples, the wireless communications system 300 may implement aspects of a wireless communications system 100 and a wireless communications system 200. For example, the wireless communications system 300 may include a UE 115-c and a UE 115-d which may be examples of UEs 115 as described with reference to FIGS. 1 and 2.

In some examples, the wireless communications system 300 may support UE cooperation and may include a set of UEs 115. For example, the wireless communications system 300 may include the UE 115-c and the UE 115-d. As described with reference to FIG. 2, in UE cooperation, the network may treat the set of UEs 115 as a single UE 115 and as such, the set of UEs 115 may collectively receive the same information from the network. To facilitate UE cooperation, a base station may include multiple TRPs 305, where each TRP may establish a communication link with at least one UE 115. For example, the TRP 305-a may establish a communication link 310 (e.g., uplink and downlink) with a UE 115-c and the TRP 305-b may establish a communication link 315 (e.g., uplink and downlink) with a UE 115-d. Additionally, the set of UEs 115 may communicate with each other over sidelink. For example, the UE 115-c may communicate with the UE 115-d using a sidelink communication link 320.

In some examples, communication between a TRP 305 and a UE 115 may fail. For example, as shown in FIG. 3, the UE 115-d and the TRP 305-d may experience a beam failure. That is, the UE 115-d may determine that a signal strength (e.g., reference signal received power (RSRP)) associated with a connected directional beam goes below a threshold. During a beam failure, the UE 115-d and the TRP 305-d may be unable to exchange control information. That is, the UE 115-d may be unable to transmit control signaling over a physical uplink control channel (PUCCH) using the communication link 315-b to the TRP 305-b and the TRP 305-b may be unable to transmit control signaling over a physical downlink control channel (PDCCH) using the communication link 315-a to the UE 115-d. Once the UE 115-d detects the beam failure, the UE 115-d may trigger a BFR operation, where the BFR may be MAC-CE-based or RRC-based.

To recover from a beam failure using the MAC-CE-based approach, the UE 115-d may transmit a report to the network via a MAC-CE that includes beam recovery information (e.g., new beam information (NBI) associated with a new candidate beam detected by the UE 115-d). In some examples, the UE 115-d may be example of a cooperative UE and the UE 115-c may be an example of a target UE. As such, the UE 115-d may provide a MAC-CE including the report to the network using UE 115-c as relay. For example, the UE 115-d may transmit the MAC-CE including the beam recovery information to the UE 115-c via sidelink communication link 320-b and the UE 115-c may forward the report to the TRP 305-a via a MAC-CE over the communication link 310-b. In some examples, in order to generate the report, the UE 115-d may utilize aperiodic CSI report triggering procedures.

As described herein, to initiate aperiodic CSI report triggering procedures, the UE 115-d may receive a CSI request from the network using MAC-CE exchange. That is, the TRP 305-a may transmit a CSI request via a MAC-CE to the UE 115-c over communication link 310-a and the UE 115-d may forward the CSI request via a MAC-CE to the UE 115-d. Using the information included in the CSI request, the UE 115-d may determine a new candidate beam, construct a report including the beam recovery information, and transmit the report to the network as described above.

In another example, as described herein, to initiate CSI triggering operations, the UE 115-d may receive a CSI request from the network via one or more DCI messages. In such example, the set of UEs 115 may receive signaling configuring the set of UEs 115 with timing offsets. For example, the set of UEs 115 may be configured with a first timing offset and a second timing offset. The TRP 305-a may transmit a CSI request via DCI to the UE 115-c over communication link 310-a and after applying the first delay, the UE 115-d may transmit decoded bits or I/Q samples of the DCI to the UE 115-d. Using the information included in the CSI request, the UE may construct a report including the beam receiver information and after the second timing delay, transmit the report to the network.

In some examples, the CSI request my include a UE ID, a panel ID, or a CC ID associated with the UE 115-d. Additionally or alternatively, the MAC-CE carrying the CSI request may include a CSI request ID. The CSI request ID may help to distinguish the CSI request from other CSI requests intended for the UE 115-d. If the target UE or the cooperative UE receives a first CSI request including a CSI request ID, the target UE or the cooperative UE may not monitor for second CSI request with the same CSI request ID until a report associated with the first CSI request is transmitted. In some examples, the MAC-CE or the DCI carrying the CSI request may also include a CSI measurement ID, a CSI-RS resource set ID, or a CSI report setting ID. Additionally or alternatively, the CSI request may include timing indicators. For example, the CSI request may include a timing indicator indicating the timing of the one or more reference signals to be measured by the UE 115-d. Using the techniques as described herein may allow a UE to recover from a beam failure using MAC-CE-based approaches as opposed to RRC-based approaches which may reduce latency.

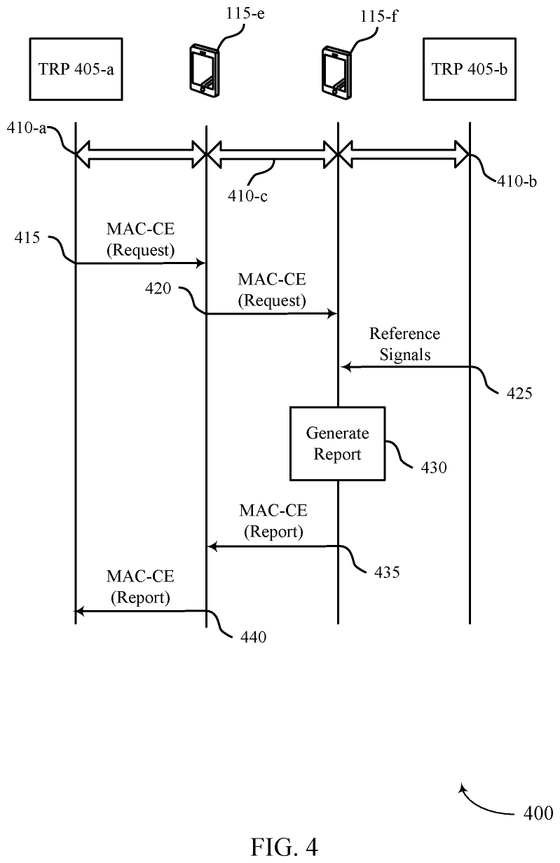

FIG. 4 illustrates an example of a process flow 400 that supports channel information exchange for UE cooperation in accordance with aspects of the present disclosure. In some examples, the process flow 400 may implement or be implemented by aspects of a wireless communications system 100, a wireless communications system 200, or a wireless communications system 300. For example, the process flow 400 may include a UE 115-e and a UE 115-f which may be examples of UEs 115 as described with reference to FIGS. 1-3. The process flow 400 may support CSI reporting procedures using MAC-CE exchange in UE cooperation. Alternative examples of the following may be implemented, where some steps are performed in a different order then described or are not performed at all. In some cases, steps may include additional features not mentioned below, or further steps may be added.

At 410-a, the UE 115-e may establish a first communication link with a TRP 405-a and at 410-b, the UE 115-f may establish a second communication with a TRP 405-b. Additionally, the UE 115-e and the UE 115-f may establish a third communication link at 410-c (e.g., sidelink communication link). In some examples, the first communication link, the second communication link, and the third communication link may be associated with the same communication protocol. Alternatively, one or more of the first communication link communication link, the second communication link, and the third communication may be associated with different communication protocols. In some examples, the UE 115-e may be an example of a target UE and the UE 115-f may be an example of a cooperative UE.

At 415, the TRP 405-a may transmit a first MAC-CE to the UE 115-e. In some examples, the first MAC-CE may include a request for channel information associated with the second communication link. For example, the first MAC-CE may include a CSI request requesting a CSI report associated with the second communication link.

At 420, the UE 115-e may transmit a second MAC-CE to the UE 115-f. In some examples, the second MAC-CE may include the request for channel information associated with the second communication link. For example, the MAC-CE may include the CSI request requesting a CSI report associated with the second communication link. That is, the UE 115-e may forward the CSI request for channel information associated with the second communication link received at 415 to the UE 115-f.

In some examples, the request for channel information may include a UE ID, A panel ID, or a CC ID corresponding to the UE 115-f. Additionally or alternatively, the request for channel information may include a CSI report ID, a CSI measurement ID, a CSI-RS resource set ID, or a CSI report setting ID. Moreover, the request for channel information may include one or more timing indicators. The one or more timing indicator may indicate one or more resource for receiving reference signals (e.g., CSI-RSs) at the UE 115—for one or more time resources for the UE 115-f to use to transmit a report including the channel information.

At 425, the UE 115-f may receive reference signals from the TRP 405-b. In some examples, the UE 115-f may determine the resources to receive the reference signals based on the request for channel information received at 420. The UE 115-f may measure the reference signals received from the TRP 405-d and determine measurement values associated with the reference signals.

At 430, the UE 115-f may generate a report including the channel information associated with the second communication link. In some examples, the channel information may include the measurement values determined at 425.

At 435, the UE 115-f may transmit a third MAC-CE to the UE 115-e including the report including the channel information associated with the second communication to the UE 115-e. For example, the third MAC-CE may include a CSI report.

At 440, the UE 115-e may transmit a fourth MAC-CE to the TRP 405-a. The fourth MAC-CE may include the report including the channel information associated with the second communication link. For example, the MAC-CE may include the CSI report. That is, the UE 115-e may forward the report including the channel information associated with the second communication link received at 435 to the UE 115-f.

In some examples, the report including the channel information may include a UE ID, A panel ID, or a CC ID corresponding to the UE 115-f. Additionally or alternatively, the request for channel information may also include a CSI report ID, a CSI measurement ID, a CSI-RS resource set ID, or a CSI report setting ID.

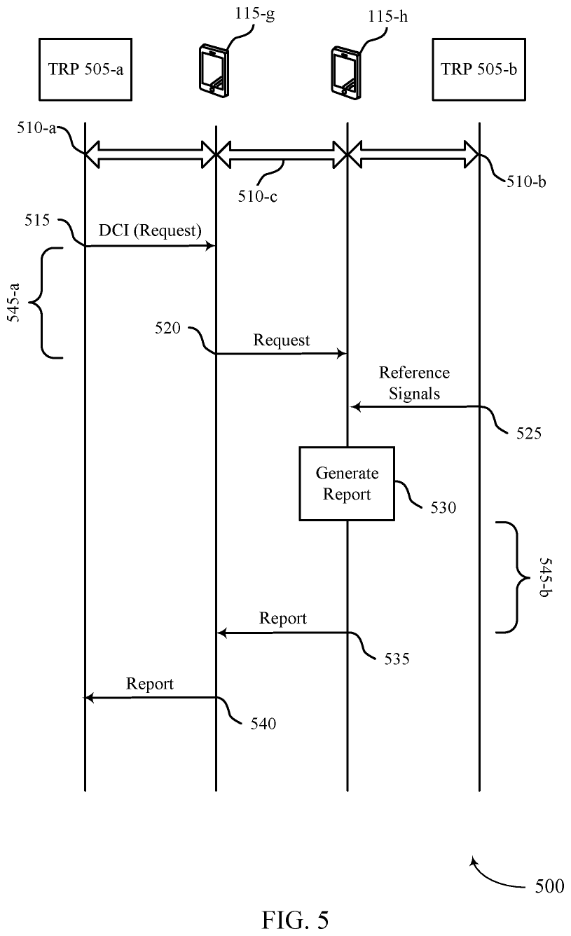

FIG. 5 illustrates an example of a process flow 500 that supports channel information exchange for UE cooperation in accordance with aspects of the present disclosure. In some examples, the process flow 500 may implement or be implemented by aspects of a wireless communications system 100, a wireless communications system 200, a wireless communications system 300, or a process flow 400. For example, the process flow 500 may include a UE 115-g and a UE 115-h which may be examples of UEs 115 as described with reference to FIGS. 1-4. The process flow 500 may support CSI reporting procedures using DCI exchange in UE cooperation. Alternative examples of the following may be implemented, where some steps are performed in a different order then described or are not performed at all. In some cases, steps may include additional features not mentioned below, or further steps may be added.

At 510-a, the UE 115-g may establish a first communication link with a TRP 505-a and at 510-b, the UE 115-h may establish a second communication with a TRP 505-b. Additionally, the UE 115-g and the UE 115-h may establish a third communication link at 510-c (e.g., sidelink communication link). In some examples, the first communication link, the second communication link, and the third communication link may be associated with the same communication protocol. Alternatively, one or more of the first communication link communication link, the second communication link, and the third communication may be associated with different communication protocols. In some examples, the UE 115-g may be an example of a target UE and the UE 115-h may be an example of a cooperative UE.

At 515, the TRP 505-a may transmit DCI to the UE 115-g. In some examples, the DCI may include a request for channel information associated with the second communication link. For example, the DCI may include a CSI request requesting a CSI report associated with the second communication link.

At 520, the UE 115-g may transmit the request for channel information associated with the second communication link to the UE 115-h. For example, the UE 115-g may transmit decoded bits or I/Q samples of the DCI received at 515. In some examples, the UE 115-g may transmit the request for channel information associated with the second communication link after a timing delay 545-a. In some examples, one or both of the UE 115-g and the UE 115-h may receive signaling configuring the UE 115-g and the UE 115-h with timing delay 545-a.

In some examples, the request for channel information may include a UE ID, A panel ID, or a CC ID corresponding to the UE 115-h. Additionally or alternatively, the request for channel information may include a CSI report ID, a CSI measurement ID, a CSI-RS resource set ID, or a CSI report setting ID. Additionally or alternatively, the request for channel information may include one or more timing indicators. The one or more timing indicator may indicate one or more resource for receiving reference signals (e.g., CSI-RSs) at the UE 115-h or one or more time resources for the UE 115-h to use to transmit a report including the channel information.

At 525, the UE 115-h may receive reference signals from the TRP 505-b. In some examples, the UE 115-h may determine the resources to receive the reference signals based on the request for channel information received at 520. The UE 115-h may measure the reference signals received from the TRP 405-d and determine measurement values associated with the reference signals.

At 530, the UE 115-h may generate a report including the channel information associated with the second communication link. In some examples, the channel information may include the measurement values determined at 425.

At 535, the UE 115-h may transmit the report including the channel information associated with the second communication to the UE 115-g.

At 540, the UE 115-g may transmit the report including the channel information associated with the second communication link to the TRP 505-a. In some examples, the UE 115-h may transmit the request for channel information associated with the second communication link after a timing delay 545-b. In some examples, one or both of the UE 115-g and the UE 115-h may receive signaling configuring the UE 115-g and the UE 115-h with timing delay 545-b from the network.

Timing delay 545-a and timing delay 545-b may be examples of additional delays for CSI triggering and reporting in the cooperative UE context. For example, when a UE 115 is operating outside of the cooperative UE context, a timing delay may be configured for CSI triggering, which may correspond to or otherwise account for a delay between the UE 115 receiving a request for channel information and the measuring a corresponding reference signal (e.g., CSI-RS) in order to obtain the channel information. Timing delay 545-a may be an additional timing delay which accounts for extra latency related to the UE 115-h receiving the request for channel information by way of the UE 115-g. Additionally or alternatively, when a UE 115 is operating outside of the cooperative UE context, a timing delay may be configured for CSI reporting, which may correspond to or otherwise account for a delay between the UE 115 receiving a reference signal to support channel information measurements (e.g., CSI-RS) and transmitting a corresponding report. Timing delay 545-b may be an additional timing delay which accounts for extra latency related to the UE 115-h transmitting the report including the channel information by way of the UE 115-g. Timing delay 545-a, timing delay 545-b, or both may be configured for the UE 115-g and the 115-h (e.g., via configuration signaling, such as RRC signaling, from the TRP 505-a, the TRP 505-b, or both to the UEs 115). For example, timing delay 545-a, timing delay 545-b, or both may be configured prior to the DCI being transmitted at 515.

In some examples, the report including the channel information may include a UE ID, A panel ID, or a CC ID corresponding to the UE 115-h. Additionally or alternatively, the request for channel information may also include a CSI report ID, a CSI measurement ID, a CSI-RS resource set ID, or a CSI report setting ID.

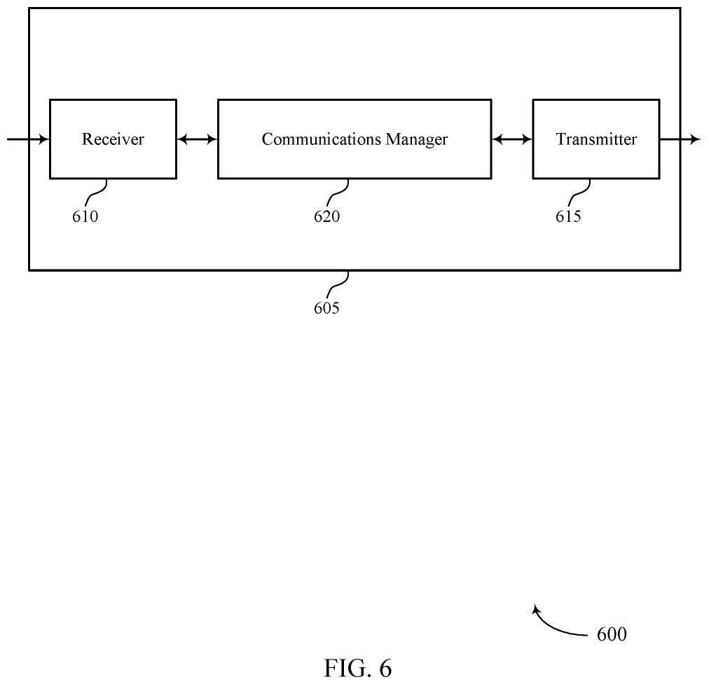

FIG. 6 shows a block diagram 600 of a device 605 that supports channel information exchange for UE cooperation in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to channel information exchange for UE cooperation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel information exchange for UE cooperation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of channel information exchange for UE cooperation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

For example, the communications manager 620 may be configured as or otherwise support a means for receiving, from a first transmission and reception point via a first communication link, a request for channel information associated with a second communication link between a second UE and a second transmission and reception point. The communications manager 620 may be configured as or otherwise support a means for relaying, to the second UE via a third communication link, the request for the channel information associated with the second communication link. The communications manager 620 may be configured as or otherwise support a means for receiving, from the second UE via the third communication link, a report including the channel information associated with the second communication link. The communications manager 620 may be configured as or otherwise support a means for relaying, to the first transmission and reception point via the first communication link, the report including the channel information associated with the second communication link.

For example, the communications manager 620 may be configured as or otherwise support a means for receiving, from a first UE via a third communication link, a request for channel information associated with a second communication link between the second UE and a second transmission and reception point, the first UE in communication with a first TRP via a first communication link. The communications manager 620 may be configured as or otherwise support a means for receiving, from the second TRP via the second communication link, one or more reference signals. The communications manager 620 may be configured as or otherwise support a means for generating a report including the channel information based on the request and the one or more reference signals. The communications manager 620 may be configured as or otherwise support a means for transmitting, to the first UE via the third communication link, the report including the channel information.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing and reduced power consumption. Utilizing cross-UE MAC-CE exchange as opposed to cross-UE DCI exchange for CSI reporting in UE cooperation may decrease processing at the device 605 (e.g., cooperative UE). A MAC-CE transmitted to the device 605 may include information related to the CSI reporting (e.g., CSI report type, timing related to CSI-RSs, etc.), whereas a decoded DCI transmitted to the device 605 may include information related to CSI reporting as well as other information (e.g., scheduling information). As such, the device 605 may utilize less processing resource to decode the MAC-CE including the CSI request than the decoded DCI including the CSI request.

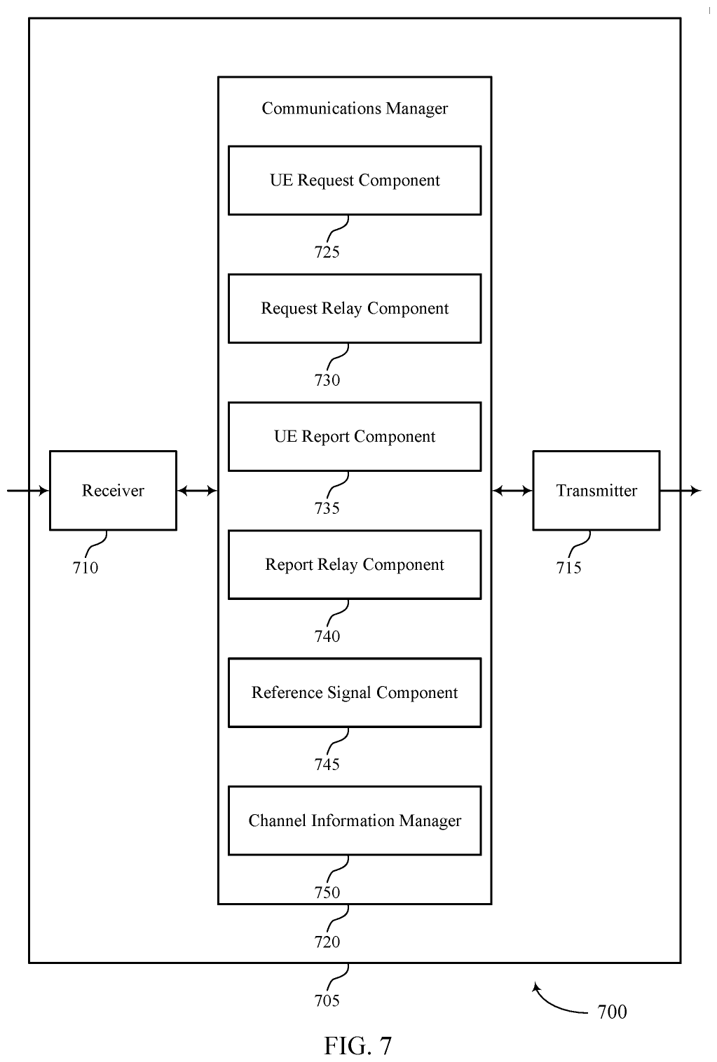

FIG. 7 shows a block diagram 700 of a device 705 that supports channel information exchange for UE cooperation in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel information exchange for UE cooperation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel information exchange for UE cooperation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel information exchange for UE cooperation as described herein. For example, the communications manager 720 may include a UE request component 725, a request relay component 730, a UE report component 735, a report relay component 740, a reference signal component 745, a channel information manager 750, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The UE request component 725 may be configured as or otherwise support a means for receiving, from a first TRP via a first communication link, a request for channel information associated with a second communication link between a second UE and a second TRP. The request relay component 730 may be configured as or otherwise support a means for relaying, to the second UE via a third communication link, the request for the channel information associated with the second communication link. The UE report component 735 may be configured as or otherwise support a means for receiving, from the second UE via the third communication link, a report including the channel information associated with the second communication link. The report relay component 740 may be configured as or otherwise support a means for relaying, to the first TRP via the first communication link, the report including the channel information associated with the second communication link.

The UE request component 725 may be configured as or otherwise support a means for receiving, from a first UE via a third communication link, a request for channel information associated with a second communication link between the second UE and a second TRP, the first UE in communication with a first TRP via a first communication link. The reference signal component 745 may be configured as or otherwise support a means for receiving, from the second TRP via the second communication link, one or more reference signals. The channel information manager 750 may be configured as or otherwise support a means for generating a report including the channel information based on the request and the one or more reference signals. The UE report component 735 may be configured as or otherwise support a means for transmitting, to the first UE via the third communication link, the report including the channel information.

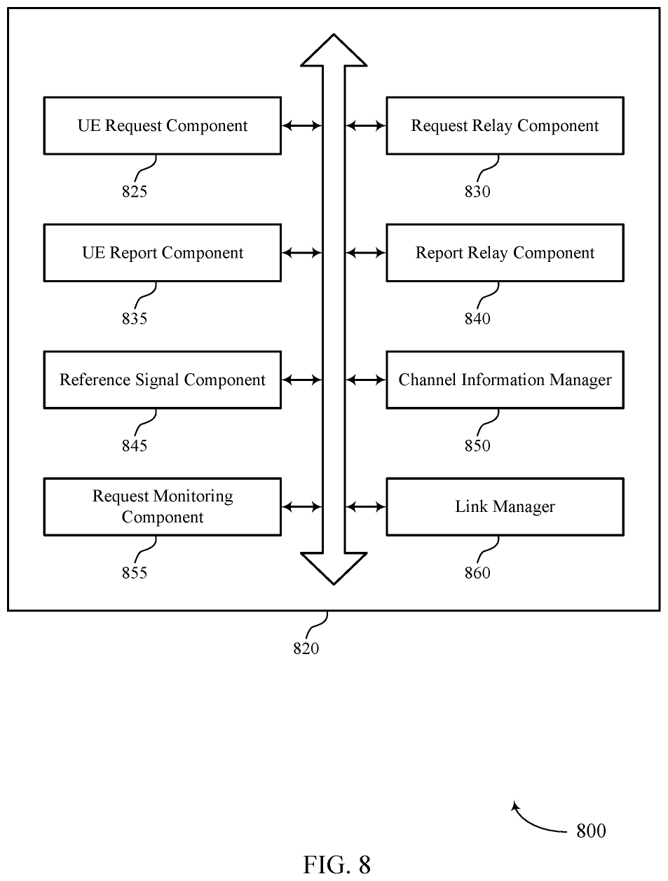

FIG. 8 shows a block diagram 800 of a communications manager 820 that supports channel information exchange for UE cooperation in accordance with aspects of the present disclosure. The communications manager 820 may be an example of aspects of a communications manager 620, a communications manager 720, or both, as described herein. The communications manager 820, or various components thereof, may be an example of means for performing various aspects of channel information exchange for UE cooperation as described herein. For example, the communications manager 820 may include a UE request component 825, a request relay component 830, a UE report component 835, a report relay component 840, a reference signal component 845, a channel information manager 850, a request monitoring component 855, a link manager 860, or any combination thereof. Each of these components may communicate, directly or indirectly, with one another (e.g., via one or more buses).

The UE request component 825 may be configured as or otherwise support a means for receiving, from a first TRP via a first communication link, a request for channel information associated with a second communication link between a second UE and a second TRP. The request relay component 830 may be configured as or otherwise support a means for relaying, to the second UE via a third communication link, the request for the channel information associated with the second communication link. The UE report component 835 may be configured as or otherwise support a means for receiving, from the second UE via the third communication link, a report including the channel information associated with the second communication link. The report relay component 840 may be configured as or otherwise support a means for relaying, to the first TRP via the first communication link, the report including the channel information associated with the second communication link.

In some examples, to support receiving the request for the channel information associated with the second communication link, the UE request component 825 may be configured as or otherwise support a means for receiving a MAC-CE, the MAC-CE including the request for the channel information associated with the second communication link.

In some examples, to support relaying the request for the channel information associated with the second communication link, the request relay component 830 may be configured as or otherwise support a means for transmitting a MAC-CE via the third communication link, the MAC-CE including information based on the request received via the first communication link.

In some examples, to support receiving the report including the channel information associated with the second communication link, the UE report component 835 may be configured as or otherwise support a means for receiving a MAC-CE, the MAC-CE including the report including the channel information associated with the second communication link.

In some examples, to support relaying the report including the channel information associated with the second communication link, the report relay component 840 may be configured as or otherwise support a means for transmitting a MAC-CE via the first communication link, the MAC-CE including information based on the report received via the third communication link.

In some examples, to support receiving the request for the channel information associated with the second communication link, the UE request component 825 may be configured as or otherwise support a means for receiving DCI, the DCI including the request for the channel information associated with the second communication link.

In some examples, to support relaying the request for the channel information associated with the second communication link, the report relay component 840 may be configured as or otherwise support a means for transmitting, via the third communication link, information based on the DCI received via the first communication link.

In some examples, relaying, to the second UE via the third communication link, the request for the channel information associated with the second communication link occurs a first duration after the first UE receives the request from the first TRP.

In some examples, at least one of the request for the channel information or the report including the channel information includes a UE ID, a panel ID, or a CC ID, or any combination thereof associated with the second UE.

In some examples, the request for the channel information includes a CSI request ID, a CSI measurement ID, a CSI-RS resource set ID, or a CSI report setting ID.

In some examples, at least one of the request for the channel information or the report including the channel information includes an indication of one or more time resources associated with a reference signal for the second communication link or one or more time resources associated with the report.

In some examples, the request monitoring component 855 may be configured as or otherwise support a means for monitoring for a second request for the channel information associated with the second communication link after relaying the report including the channel information associated with the second communication link.

In some examples, the report including the channel information includes a periodic CSI report or an aperiodic CSI report.

In some examples, the first communication link is associated with a first communication protocol and the third communication link is associated with a second communication protocol.

In some examples, the UE request component 825 may be configured as or otherwise support a means for receiving, from a first UE via a third communication link, a request for channel information associated with a second communication link between the second UE and a second transmission and reception point, the first UE in communication with a first TRP via a first communication link. The reference signal component 845 may be configured as or otherwise support a means for receiving, from the second TRP via the second communication link, one or more reference signals. The channel information manager 850 may be configured as or otherwise support a means for generating a report including the channel information based on the request and the one or more reference signals. In some examples, the UE report component 835 may be configured as or otherwise support a means for transmitting, to the first UE via the third communication link, the report including the channel information.

In some examples, to support receiving the request for the channel information associated with the second communication link, the UE request component 825 may be configured as or otherwise support a means for receiving a MAC-CE, the MAC-CE including the request for the channel information associated with the second communication link.

In some examples, to support transmitting the report including the channel information associated with the second communication link, the UE report component 835 may be configured as or otherwise support a means for transmitting a MAC-CE, the MAC-CE including the report including the channel information associated with the second communication link.

In some examples, to support receiving the request for the channel information associated with the second communication link, the UE request component 825 may be configured as or otherwise support a means for receiving, via the third communication link, information based on DCI associated with the first communication link.

In some examples, transmitting, to the first UE via the first communication link, the report including the channel information associated with the second communication link occurs a first duration after the second UE receives the one or more reference signals.

In some examples, at least one of the request for the channel information and the report including the channel information includes a UE ID, a panel ID, or a CC ID, or any combination thereof associated with the second UE.

In some examples, the request for the channel information includes a CSI request ID, a CSI measurement ID, a CSI-RS resource set ID, or a CSI report setting ID.

In some examples, at least one of the request for the channel information or the report includes the channel information includes an indication of one or more time resources associated with the one or more reference signals or one or more time resources associated with the report.

In some examples, the request monitoring component 855 may be configured as or otherwise support a means for monitoring for a second request for channel information associated with the second communication link after transmitting the report including the channel information associated with the second communication link.

In some examples, the report including the channel information includes a periodic CSI report or an aperiodic CSI report.

In some examples, the link manager 860 may be configured as or otherwise support a means for detecting an RLF associated with the second communication link, where receiving the request for the channel information associated with the second communication link is based on detecting the RLF associated with the second communication link.

In some examples, the link manager 860 may be configured as or otherwise support a means for transmitting, to the first UE, signaling indicating the RLF associated with the second communication link, where receiving the request for the channel information associated with the second communication link is based at least in part on transmitting the signaling.

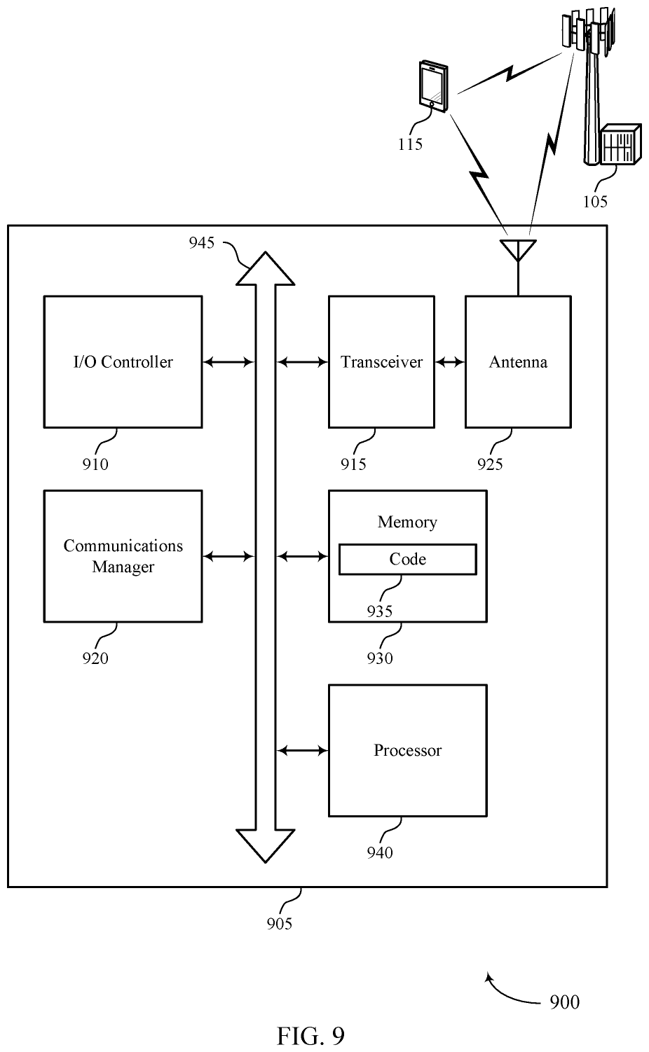

FIG. 9 shows a diagram of a system 900 including a device 905 that supports channel information exchange for UE cooperation in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting channel information exchange for UE cooperation). For example, the device 905 or a component of the device 905 may include a processor 940 and memory 930 coupled to the processor 940, the processor 940 and memory 930 configured to perform various functions described herein.

For example, the communications manager 920 may be configured as or otherwise support a means for receiving, from a first TRP via a first communication link, a request for channel information associated with a second communication link between a second UE and a second TRP. The communications manager 920 may be configured as or otherwise support a means for relaying, to the second UE via a third communication link, the request for the channel information associated with the second communication link. The communications manager 920 may be configured as or otherwise support a means for receiving, from the second UE via the third communication link, a report including the channel information associated with the second communication link. The communications manager 920 may be configured as or otherwise support a means for relaying, to the first TRP via the first communication link, the report including the channel information associated with the second communication link.

For example, the communications manager 920 may be configured as or otherwise support a means for receiving, from a first UE via a third communication link, a request for channel information associated with a second communication link between the second UE and a second TRP, the first UE in communication with a first TRP via a first communication link. The communications manager 920 may be configured as or otherwise support a means for receiving, from the second TRP via the second communication link, one or more reference signals. The communications manager 920 may be configured as or otherwise support a means for generating a report including the channel information based on the request and the one or more reference signals. The communications manager 920 may be configured as or otherwise support a means for transmitting, to the first UE via the third communication link, the report including the channel information.

By including or configuring the communications manager 920 in accordance with examples as described herein, the device 905 may support techniques for improved communication reliability and improved coordination between devices. By supporting cross-UE MAC-CE exchange, the device 905 may provide channel information to the network multiple ways. For example, the device 905 may transmit a CSI report to the network via another device 905 or the device 905 may transmit a CSI report to the network directly. If one path of communication fails, the device 905 may transmit the CSI report to the network via the other path of communication thereby increasing reliability of CSI reporting.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of channel information exchange for UE cooperation as described herein, or the processor 940 and the memory 930 may be otherwise configured to perform or support such operations.

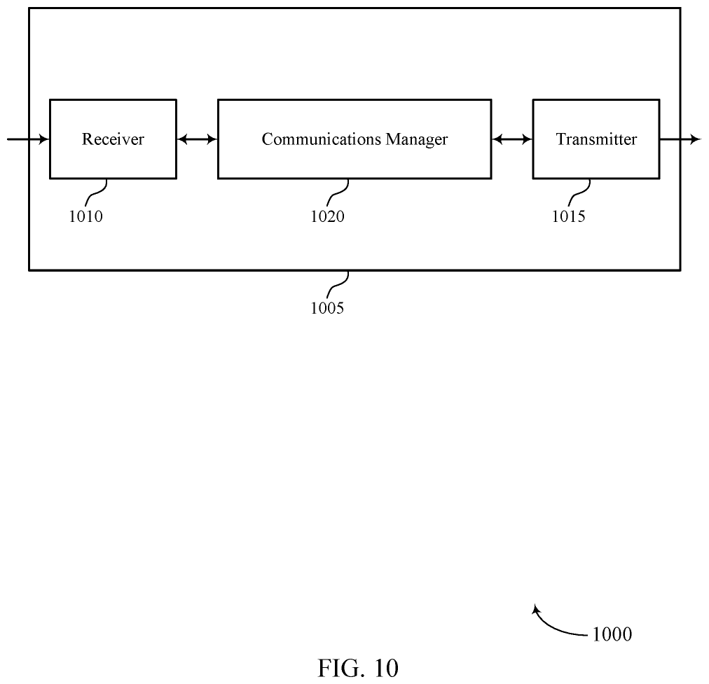

FIG. 10 shows a block diagram 1000 of a device 1005 that supports channel information exchange for UE cooperation in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to channel information exchange for UE cooperation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to channel information exchange for UE cooperation). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of channel information exchange for UE cooperation as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

For example, the communications manager 1020 may be configured as or otherwise support a means for establishing a first communication link with a first UE. The communications manager 1020 may be configured as or otherwise support a means for transmitting, to the first UE via the first communication link, a request for channel information associated with a second communication link between a second UE and the base station. The communications manager 1020 may be configured as or otherwise support a means for receiving, from the first UE via the first communication link, the report including the channel information associated with the second communication link.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing and reduced power consumption.

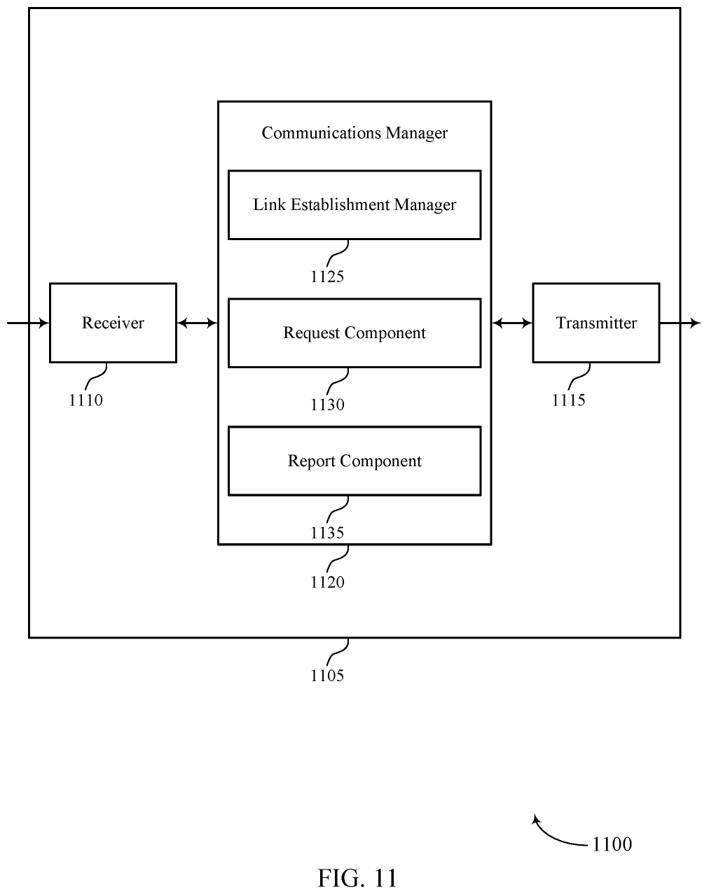

FIG. 11 shows a block diagram 1100 of a device 1105 that supports channel information exchange for UE cooperation in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to channel information exchange for UE cooperation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to channel information exchange for UE cooperation). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of channel information exchange for UE cooperation as described herein. For example, the communications manager 1120 may include a link establishment manager 1125, a request component 1130, a report component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The link establishment manager 1125 may be configured as or otherwise support a means for establishing a first communication link with a first UE. The request component 1130 may be configured as or otherwise support a means for transmitting, to the first UE via the first communication link, a request for channel information associated with a second communication link between a second UE and the base station. The report component 1135 may be configured as or otherwise support a means for receiving, from the first UE via the first communication link, the report including the channel information associated with the second communication link.

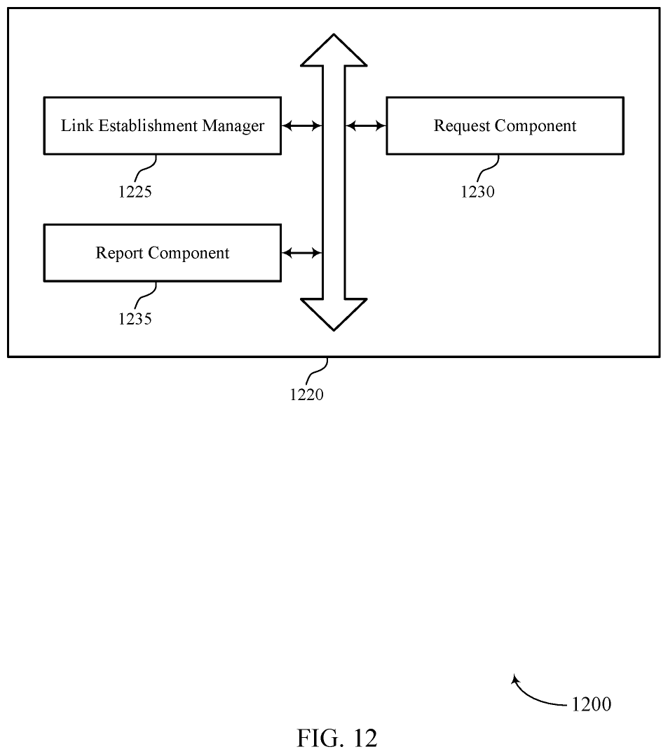

FIG. 12 shows a block diagram 1200 of a communications manager 1220 that supports channel information exchange for UE cooperation in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of channel information exchange for UE cooperation as described herein. For example, the communications manager 1220 may include a link establishment manager 1225, a request component 1230, a report component 1235, or any combination thereof. Each of these components may communicate, directly or indirectly, with one another (e.g., via one or more buses).

The link establishment manager 1225 may be configured as or otherwise support a means for establishing a first communication link with a first UE. The request component 1230 may be configured as or otherwise support a means for transmitting, to the first UE via the first communication link, a request for channel information associated with a second communication link between a second UE and the base station. The report component 1235 may be configured as or otherwise support a means for receiving, from the first UE via the first communication link, the report including the channel information associated with the second communication link.

In some examples, transmitting the request for the channel information associated with the second communication link includes transmitting a MAC-CE, the MAC-CE including the request for the channel information associated with the second communication link. In some examples, receiving the report including the channel information associated with the second communication link includes receiving a MAC-CE, the MAC-CE including the report including the channel information associated with the second communication link.

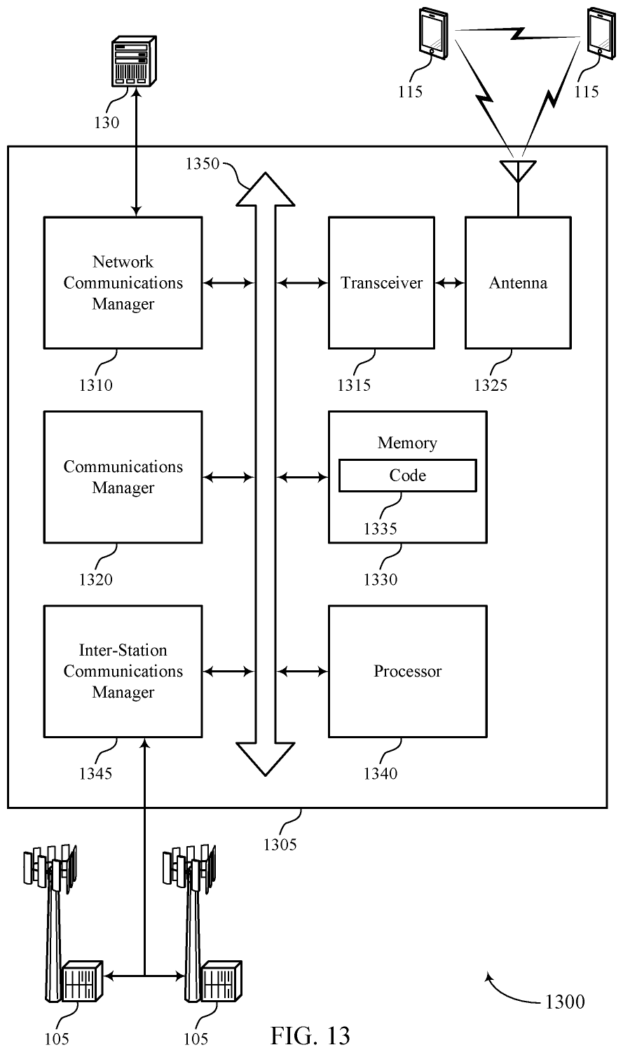

FIG. 13 shows a diagram of a system 1300 including a device 1305 that supports channel information exchange for UE cooperation in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting channel information exchange for UE cooperation). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

For example, the communications manager 1320 may be configured as or otherwise support a means for establishing a first communication link with a first UE. The communications manager 1320 may be configured as or otherwise support a means for transmitting, to the first UE via the first communication link, a request for channel information associated with a second communication link between a second UE and the base station. The communications manager 1320 may be configured as or otherwise support a means for receiving, from the first UE via the first communication link, the report including the channel information associated with the second communication link.

By including or configuring the communications manager 1320 in accordance with examples as described herein, the device 1305 may support techniques for improved communication reliability and reduced latency.

In some examples, the communications manager 1320 may be configured to perform various operations (e.g., receiving, monitoring, transmitting) using or otherwise in cooperation with the transceiver 1315, the one or more antennas 1325, or any combination thereof. For example, the communications manager 1320 may be configured to receive or transmit messages or other signaling as described herein via the transceiver 1315. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of channel information exchange for UE cooperation as described herein, or the processor 1340 and the memory 1330 may be otherwise configured to perform or support such operations.

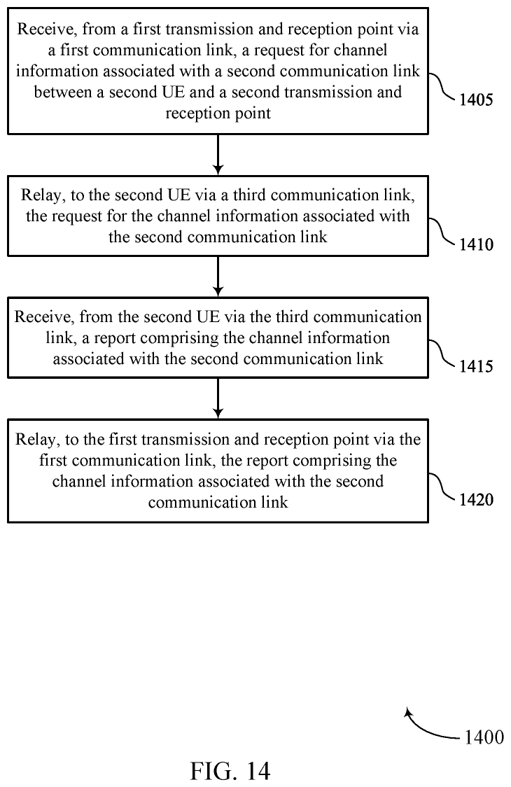

FIG. 14 shows a flowchart illustrating a method 1400 that supports channel information exchange for UE cooperation in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a first TRP via a first communication link, a request for channel information associated with a second communication link between a second UE and a second TRP. The operations of 1405 may be performed in accordance with examples as disclosed herein. In some examples, aspects of the operations of 1405 may be performed by a UE request component 825 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1410, the method may include relaying, to the second UE via a third communication link, the request for the channel information associated with the second communication link. The operations of 1410 may be performed in accordance with examples as disclosed herein. In some examples, aspects of the operations of 1410 may be performed by a request relay component 830 as described with reference to FIG. 8. Additionally or alternatively, means for performing 1410 may, but not necessarily, include, for example, antenna 925, transceiver 915, communications manager 920, memory 930 (including code 935), processor 940 and/or bus 945.

At 1415, the method may include receiving, from the second UE via the third communication link, a report including the channel information associated with the second communication link. The operations of 1415 may be performed in accordance with examples as disclosed herein. In some examples, aspects of the operations of 1415 may be performed by a UE report component 835 as described with reference to FIG. 8. Additionally or alternatively, means for performing 1415 may, but not necessarily, include, for example, antenna 925, transceiver 915, communications manager 920, memory 930 (including code 935), processor 940 and/or bus 945.

At 1420, the method may include relaying, to the first TRP via the first communication link, the report including the channel information associated with the second communication link. The operations of 1420 may be performed in accordance with examples as disclosed herein. In some examples, aspects of the operations of 1420 may be performed by a report relay component 840 as described with reference to FIG. 8. Additionally or alternatively, means for performing 1420 may, but not necessarily, include, for example, antenna 925, transceiver 915, communications manager 920, memory 930 (including code 935), processor 940 and/or bus 945.

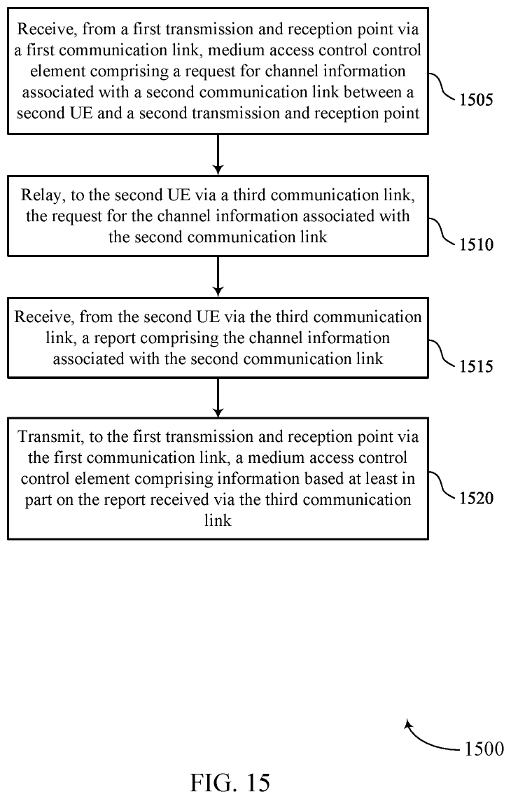

FIG. 15 shows a flowchart illustrating a method 1500 that supports channel information exchange for UE cooperation in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a first TRP via a first communication link, a MAC-CE including a request for channel information associated with a second communication link between a second UE and a second TRP. The operations of 1505 may be performed in accordance with examples as disclosed herein. In some examples, aspects of the operations of 1505 may be performed by a UE request component 825 as described with reference to FIG. 8. Additionally or alternatively, means for performing 1505 may, but not necessarily, include, for example, antenna 925, transceiver 915, communications manager 920, memory 930 (including code 935), processor 940 and/or bus 945.

At 1510, the method may include relaying, to the second UE via a third communication link, the request for the channel information associated with the second communication link. The operations of 1510 may be performed in accordance with examples as disclosed herein. In some examples, aspects of the operations of 1510 may be performed by a request relay component 830 as described with reference to FIG. 8. Additionally or alternatively, means for performing 1510 may, but not necessarily, include, for example, antenna 925, transceiver 915, communications manager 920, memory 930 (including code 935), processor 940 and/or bus 945.

At 1515, the method may include receiving, from the second UE via the third communication link, a report including the channel information associated with the second communication link. The operations of 1515 may be performed in accordance with examples as disclosed herein. In some examples, aspects of the operations of 1515 may be performed by a UE report component 835 as described with reference to FIG. 8. Additionally or alternatively, means for performing 1515 may, but not necessarily, include, for example, antenna 925, transceiver 915, communications manager 920, memory 930 (including code 935), processor 940 and/or bus 945.

At 1520, the method may include transmitting, to the first TRP via the first communication link, a MAC-CE including information based on the report received via the third communication link. The operations of 1520 may be performed in accordance with examples as disclosed herein. In some examples, aspects of the operations of 1520 may be performed by a report relay component 840 as described with reference to FIG. 8. Additionally or alternatively, means for performing 1520 may, but not necessarily, include, for example, antenna 925, transceiver 915, communications manager 920, memory 930 (including code 935), processor 940 and/or bus 945.

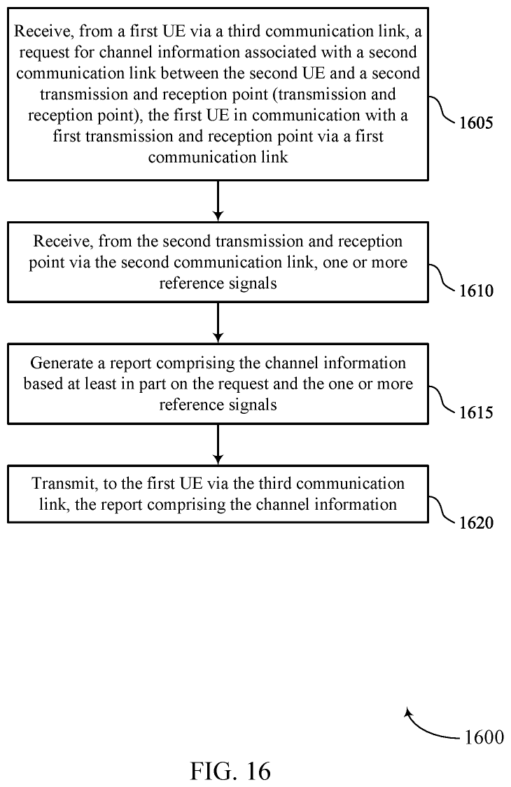

FIG. 16 shows a flowchart illustrating a method 1600 that supports channel information exchange for UE cooperation in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving, from a first UE via a third communication link, a request for channel information associated with a second communication link between the second UE and a second TRP, the first UE in communication with a first TRP via a first communication link. The operations of 1605 may be performed in accordance with examples as disclosed herein. In some examples, aspects of the operations of 1605 may be performed by a UE request component 825 as described with reference to FIG. 8. Additionally or alternatively, means for performing 1605 may, but not necessarily, include, for example, antenna 925, transceiver 915, communications manager 920, memory 930 (including code 935), processor 940 and/or bus 945.

At 1610, the method may include receiving, from the second TRP via the second communication link, one or more reference signals. The operations of 1610 may be performed in accordance with examples as disclosed herein. In some examples, aspects of the operations of 1610 may be performed by a reference signal component 845 as described with reference to FIG. 8. Additionally or alternatively, means for performing 1610 may, but not necessarily, include, for example, antenna 925, transceiver 915, communications manager 920, memory 930 (including code 935), processor 940 and/or bus 945.

At 1615, the method may include generating a report including the channel information based on the request and the one or more reference signals. The operations of 1615 may be performed in accordance with examples as disclosed herein. In some examples, aspects of the operations of 1615 may be performed by a channel information manager 850 as described with reference to FIG. 8. Additionally or alternatively, means for performing 1615 may, but not necessarily, include, for example, antenna 925, transceiver 915, communications manager 920, memory 930 (including code 935), processor 940 and/or bus 945.

At 1620, the method may include transmitting, to the first UE via the third communication link, the report including the channel information. The operations of 1620 may be performed in accordance with examples as disclosed herein. In some examples, aspects of the operations of 1620 may be performed by a UE report component 835 as described with reference to FIG. 8. Additionally or alternatively, means for performing 1620 may, but not necessarily, include, for example, antenna 925, transceiver 915, communications manager 920, memory 930 (including code 935), processor 940 and/or bus 945.

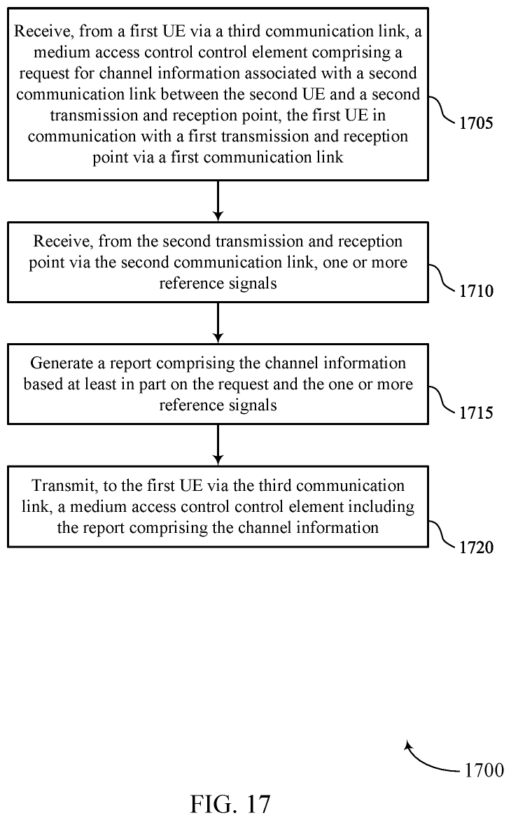

FIG. 17 shows a flowchart illustrating a method 1700 that supports channel information exchange for UE cooperation in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include receiving, from a first UE via a third communication link, a MAC-CE including a request for channel information associated with a second communication link between the second UE and a second TRP, the first UE in communication with a first TRP via a first communication link. The operations of 1705 may be performed in accordance with examples as disclosed herein. In some examples, aspects of the operations of 1705 may be performed by a UE request component 825 as described with reference to FIG. 8. Additionally or alternatively, means for performing 1705 may, but not necessarily, include, for example, antenna 925, transceiver 915, communications manager 920, memory 930 (including code 935), processor 940 and/or bus 945.

At 1710, the method may include receiving, from the second TRP via the second communication link, one or more reference signals. The operations of 1710 may be performed in accordance with examples as disclosed herein. In some examples, aspects of the operations of 1710 may be performed by a reference signal component 845 as described with reference to FIG. 8. Additionally or alternatively, means for performing 1710 may, but not necessarily, include, for example, antenna 925, transceiver 915, communications manager 920, memory 930 (including code 935), processor 940 and/or bus 945.

At 1715, the method may include generating a report including the channel information based on the request and the one or more reference signals. The operations of 1715 may be performed in accordance with examples as disclosed herein. In some examples, aspects of the operations of 1715 may be performed by a channel information manager 850 as described with reference to FIG. 8. Additionally or alternatively, means for performing 1715 may, but not necessarily, include, for example, antenna 925, transceiver 915, communications manager 920, memory 930 (including code 935), processor 940 and/or bus 945.

At 1720, the method may include transmitting, to the first UE via the third communication link, a MAC-CE including the report including the channel information. The operations of 1720 may be performed in accordance with examples as disclosed herein. In some examples, aspects of the operations of 1720 may be performed by a UE report component 835 as described with reference to FIG. 8. Additionally or alternatively, means for performing 1720 may, but not necessarily, include, for example, antenna 925, transceiver 915, communications manager 920, memory 930 (including code 935), processor 940 and/or bus 945.

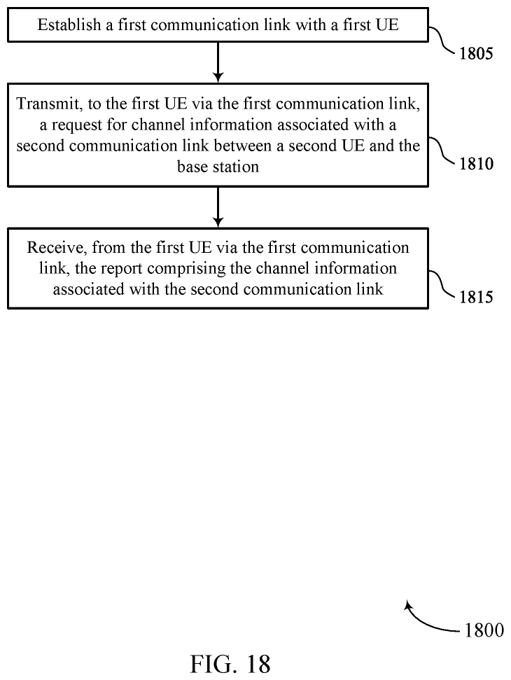

FIG. 18 shows a flowchart illustrating a method 1800 that supports channel information exchange for UE cooperation in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include establishing a first communication link with a first UE. The operations of 1805 may be performed in accordance with examples as disclosed herein. In some examples, aspects of the operations of 1805 may be performed by a link establishment manager 1225 as described with reference to FIG. 12. Additionally or alternatively, means for performing 1805 may, but not necessarily, include, for example, antenna 1325, transceiver 1315, communications manager 1320, memory 1330 (including code 1335), processor 1340 and/or bus 1345.

At 1810, the method may include transmitting, to the first UE via the first communication link, a request for channel information associated with a second communication link between a second UE and the base station. The operations of 1810 may be performed in accordance with examples as disclosed herein. In some examples, aspects of the operations of 1810 may be performed by a request component 1230 as described with reference to FIG. 12. Additionally or alternatively, means for performing 1810 may, but not necessarily, include, for example, antenna 1325, transceiver 1315, communications manager 1320, memory 1330 (including code 1335), processor 1340 and/or bus 1345.

At 1815, the method may include receiving, from the first UE via the first communication link, the report including the channel information associated with the second communication link. The operations of 1815 may be performed in accordance with examples as disclosed herein. In some examples, aspects of the operations of 1815 may be performed by a report component 1235 as described with reference to FIG. 12. Additionally or alternatively, means for performing 1815 may, but not necessarily, include, for example, antenna 1325, transceiver 1315, communications manager 1320, memory 1330 (including code 1335), processor 1340 and/or bus 1345.

The following provides an overview of aspects of the present disclosure:

Aspect 1: A method of wireless communication at a first UE, comprising: receiving, from a first TRP via a first communication link, a request for channel information associated with a second communication link between a second UE and a second TRP; relaying, to the second UE via a third communication link, the request for the channel information associated with the second communication link; receiving, from the second UE via the third communication link, a report comprising the channel information associated with the second communication link; and relaying, to the first TRP via the first communication link, the report comprising the channel information associated with the second communication link.

Aspect 2: The method of aspect 1, wherein receiving the request for the channel information associated with the second communication link comprises: receiving a MAC-CE, the MAC-CE comprising the request for the channel information associated with the second communication link.

Aspect 3: The method of any of aspects 1 through 2, wherein relaying the request for the channel information associated with the second communication link comprises: transmitting a MAC-CE via the third communication link, the MAC-CE comprising information based at least in part on the request received via the first communication link.

Aspect 4: The method of any of aspects 1 through 3, wherein receiving the report comprising the channel information associated with the second communication link comprises: receiving a MAC-CE, the MAC-CE comprising the report comprising the channel information associated with the second communication link.

Aspect 5: The method of any of aspects 1 through 4, wherein relaying the report comprising the channel information associated with the second communication link comprises: transmitting a MAC-CE via the first communication link, the MAC-CE comprising information based at least in part on the report received via the third communication link.

Aspect 6: The method of aspect 1, wherein receiving the request for the channel information associated with the second communication link comprises:

receiving DCI, the DCI comprising the request for the channel information associated with the second communication link.

Aspect 7: The method of aspect 6, wherein relaying the request for the channel information associated with the second communication link comprises: transmitting, via the third communication link, information based at least in part on the DCI received via the first communication link.

Aspect 8: The method of aspect 7, wherein relaying, to the second UE via the third communication link, the request for the channel information associated with the second communication link occurs a first duration after the first UE receives the request from the first TRP.

Aspect 9: The method of any of aspects 1 through 8, wherein at least one of the request for the channel information or the report comprising the channel information comprises a UE ID, a panel ID, or a CC ID, or any combination thereof associated with the second UE.

Aspect 10: The method of any of aspects 1 through 9, wherein the request for the channel information comprises a CSI request ID, a CSI measurement ID, a CSI-RS resource set ID, or a CSI report setting ID.

Aspect 11: The method of any of aspects 1 through 10, wherein at least one of the request for the channel information or the report comprising the channel information comprises an indication of one or more time resources associated with a reference signal for the second communication link or one or more time resources associated with the report.

Aspect 12: The method of any of aspects 1 through 11, further comprising: monitoring for a second request for the channel information associated with the second communication link after relaying the report comprising the channel information associated with the second communication link.

Aspect 13: The method of any of aspects 1 through 12, wherein the report comprising the channel information comprises a periodic CSI report or an aperiodic CSI report.

Aspect 14: The method of any of aspects 1 through 13, wherein the first communication link is associated with a first communication protocol and the third communication link is associated with a second communication protocol.

Aspect 15: A method of wireless communication at a second UE, comprising: receiving, from a first UE via a third communication link, a request for channel information associated with a second communication link between the second UE and a second TRP, the first UE in communication with a first TRP via a first communication link; receiving, from the second TRP via the second communication link, one or more reference signals; generating a report comprising the channel information based at least in part on the request and the one or more reference signals; and transmitting, to the first UE via the third communication link, the report comprising the channel information.

Aspect 16: The method of aspect 15, wherein receiving the request for the channel information associated with the second communication link comprises: receiving a MAC-CE, the MAC-CE comprising the request for the channel information associated with the second communication link.

Aspect 17: The method of any of aspects 15 through 16, wherein transmitting the report comprising the channel information associated with the second communication link comprises: transmitting a MAC-CE, the MAC-CE comprising the report comprising the channel information associated with the second communication link.

Aspect 18: The method of aspect 15, wherein receiving the request for the channel information associated with the second communication link comprises: receiving, via the third communication link, information based at least in part on DCI associated with the first communication link.

Aspect 19: The method of aspect 18, wherein transmitting, to the first UE via the first communication link, the report comprising the channel information associated with the second communication link occurs a first duration after the second UE receives the one or more reference signals.

Aspect 20: The method of any of aspects 15 through 19, wherein at least one of the request for the channel information and the report comprising the channel information comprises a UE ID, a panel ID, or a CC ID, or any combination thereof associated with the second UE.

Aspect 21: The method of any of aspects 15 through 20, wherein the request for the channel information comprises a CSI request ID, a CSI measurement ID, a CSI-RS resource set ID, or a CSI report setting ID.

Aspect 22: The method of any of aspects 15 through 21, wherein at least one of the request for the channel information or the report comprises the channel information comprises an indication of one or more time resources associated with the one or more reference signals or one or more time resources associated with the report.

Aspect 23: The method of any of aspects 15 through 22, further comprising: monitoring for a second request for channel information associated with the second communication link after transmitting the report comprising the channel information associated with the second communication link.

Aspect 24: The method of any of aspects 15 through 23, wherein the report comprising the channel information comprises a periodic CSI report or an aperiodic CSI report.

Aspect 25: The method of any of aspects 15 through 24, further comprising: detecting an RLF associated with the second communication link, wherein receiving the request for the channel information associated with the second communication link is based at least in part on detecting the RLF associated with the second communication link.

Aspect 26: The method of aspect 25, further comprising: transmitting, to the first UE, signaling indicating the RLF associated with the second communication link, wherein receiving the request for the channel information associated with the second communication link is based at least in part on transmitting the signaling.

Aspect 27: A method of wireless communication at a base station, comprising: establishing a first communication link with a first UE; transmitting, to the first UE via the first communication link, a request for channel information associated with a second communication link between a second UE and the base station; and receiving, from the first UE via the first communication link, the report comprising the channel information associated with the second communication link.

Aspect 28: The method of aspect 27, wherein transmitting the request for the channel information associated with the second communication link comprises transmitting a MAC-CE, the MAC-CE comprising the request for the channel information associated with the second communication link; and receiving the report comprising the channel information associated with the second communication link comprises receiving a MAC-CE, the MAC-CE comprising the report comprising the channel information associated with the second communication link.

Aspect 29: An apparatus comprising a processor; a transceiver coupled with the processor; memory coupled with the processor, the memory and the processor configured to cause the apparatus to perform a method of any of aspects 1 through 14.

Aspect 30: An apparatus comprising at least one means for performing a method of any of aspects 1 through 14.

Aspect 31: A non-transitory computer-readable medium storing code the code comprising instructions executable by a processor to perform a method of any of aspects 1 through 14.

Aspect 32: An apparatus comprising a processor; a transceiver coupled with the processor; memory coupled with the processor, the memory and the processor configured to cause the apparatus to perform a method of any of aspects 15 through 26.

Aspect 33: An apparatus comprising at least one means for performing a method of any of aspects 15 through 26.

Aspect 34: A non-transitory computer-readable medium storing code the code comprising instructions executable by a processor to perform a method of any of aspects 15 through 26.

Aspect 35: An apparatus comprising a processor; a transceiver coupled with the processor; memory coupled with the processor, the memory and the processor configured to cause the apparatus to perform a method of any of aspects 27 through 28.

Aspect 36: An apparatus comprising at least one means for performing a method of any of aspects 27 through 28.

Aspect 37: A non-transitory computer-readable medium storing code the code comprising instructions executable by a processor to perform a method of any of aspects 27 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method of wireless communication at a first user equipment (UE), comprising:
receiving, from a first transmission and reception point via a first 3 communication link, a request for channel information associated with a second communication link between a second UE and a second transmission and reception point;
relaying, to the second UE via a third communication link, the request for the channel information associated with the second communication link;
receiving, from the second UE via the third communication link, a report comprising the channel information associated with the second communication link; and
relaying, to the first transmission and reception point via the first 10 communication link, the report comprising the channel information associated with the second communication link.

2. The method of claim 1, wherein receiving the request for the channel information associated with the second communication link comprises:
receiving a medium access control control element, the medium access control control element comprising the request for the channel information associated with the second communication link.

3. The method of claim 1, wherein relaying the request for the channel information associated with the second communication link comprises:
transmitting a medium access control control element via the third communication link, the medium access control control element comprising information based at least in part on the request received via the first communication link.

4. The method of claim 1, wherein receiving the report comprising the channel information associated with the second communication link comprises:
receiving a medium access control control element, the medium access control control element comprising the report comprising the channel information associated with the second communication link.

5. The method of claim 1, wherein relaying the report comprising the channel information associated with the second communication link comprises:
transmitting a medium access control control element via the first communication link, the medium access control control element comprising information based at least in part on the report received via the third communication link.

6. The method of claim 1, wherein receiving the request for the channel information associated with the second communication link comprises:
receiving downlink control information, the downlink control information comprising the request for the channel information associated with the second communication link.

7. The method of claim 6, wherein relaying the request for the channel information associated with the second communication link comprises:
transmitting, via the third communication link, information based at least in part on the downlink control information received via the first communication link.

8. The method of claim 7, wherein relaying, to the second UE via the third communication link, the request for the channel information associated with the second communication link occurs a first duration after the first UE receives the request from the first transmission and reception point.

9. The method of claim 1, wherein at least one of the request for the channel information or the report comprising the channel information comprises a UE identity (ID), a panel ID, or a component carrier ID, or any combination thereof associated with the second UE.

10. The method of claim 1, wherein the request for the channel information comprises a channel state information request identity (ID), a channel state information measurement ID, a channel state information reference signal resource set ID, or a channel state information report setting ID.

11. The method of claim 1, wherein at least one of the request for the channel information or the report comprising the channel information comprises an indication of one or more time resources associated with a reference signal for the second communication link or one or more time resources associated with the report.

12. The method of claim 1, further comprising:
monitoring for a second request for the channel information associated with the second communication link after relaying the report comprising the channel information associated with the second communication link.

13. The method of claim 1, wherein the report comprising the channel information comprises a periodic channel state information report or an aperiodic channel state information report.

14. The method of claim 1, wherein the first communication link is associated with a first communication protocol and the third communication link is associated with a second communication protocol.

15. A method of wireless communication at a second user equipment (UE), comprising:
receiving, from a first UE via a third communication link, a request for channel information associated with a second communication link between the second UE and a second transmission and reception point, the first UE in communication with a first transmission and reception point via a first communication link;
receiving, from the second transmission and reception point via the second communication link, one or more reference signals;
generating a report comprising the channel information based at least in part on the request and the one or more reference signals; and
transmitting, to the first UE via the third communication link, the report comprising the channel information.

16. The method of claim 15, wherein receiving the request for the channel information associated with the second communication link comprises:
receiving a medium access control control element, the medium access control control element comprising the request for the channel information associated with the second communication link.

17. The method of claim 15, wherein transmitting the report comprising the channel information associated with the second communication link comprises:
transmitting a medium access control control element, the medium access control control element comprising the report comprising the channel information associated with the second communication link.

18. The method of claim 15, wherein receiving the request for the channel information associated with the second communication link comprises:
receiving, via the third communication link, information based at least in part on downlink control information associated with the first communication link.

19. The method of claim 18, wherein transmitting, to the first UE via the first communication link, the report comprising the channel information associated with the second communication link occurs a first duration after the second UE receives the one or more reference signals.

20. The method of claim 15, wherein at least one of the request for the channel information and the report comprising the channel information comprises a UE identity (ID), a panel ID, or a component carrier ID, or any combination thereof associated with the second UE.

21. The method of claim 15, wherein the request for the channel information comprises a channel state information request identity (ID), a channel state information measurement ID, a channel state information reference signal resource set ID, or a channel state information report setting ID.

22. The method of claim 15, wherein at least one of the request for the channel information or the report comprises the channel information comprises an indication of one or more time resources associated with the one or more reference signals or one or more time resources associated with the report.

23. The method of claim 15, further comprising:
monitoring for a second request for channel information associated with the second communication link after transmitting the report comprising the channel information associated with the second communication link.

24. The method of claim 15, wherein the report comprising the channel information comprises a periodic channel state information report or an aperiodic channel state information report.

25. The method of claim 15, further comprising:
detecting a radio link failure associated with the second communication link, wherein receiving the request for the channel information associated with the second communication link is based at least in part on detecting the radio link failure associated with the second communication link.

26. The method of claim 25, further comprising:
transmitting, to the first UE, signaling indicating the radio link failure associated with the second communication link, wherein receiving the request for the channel information associated with the second communication link is based at least in part on transmitting the signaling.

27. A method of wireless communication at a base station, comprising:
establishing a first communication link with a first UE;
transmitting, to the first UE via the first communication link, a request for channel information associated with a second communication link between a second UE and the base station; and
receiving, from the first UE via the first communication link, a report comprising the channel information associated with the second communication link.

28. The method of claim 27, wherein:
transmitting the request for the channel information associated with the second communication link comprises transmitting a first medium access control control element, the first medium access control control element comprising the request for the channel information associated with the second communication link; and
receiving the report comprising the channel information associated with the second communication link comprises receiving a second medium access control control element, the second medium access control control element comprising the report comprising the channel information associated with the second communication link.

29. An apparatus for wireless communication comprising:
a processor of a first user equipment (UE);
a transceiver; and
memory in electronic communication with the processor, the memory and the processor configured to cause the apparatus to:
receive, via the transceiver, from a first transmission and reception point via a first communication link, a request for channel information associated with a second communication link between a second UE and a second transmission and reception point;
relay, via the transceiver, to the second UE via a third communication link, the request for the channel information associated with the second communication link;
receive, via the transceiver, from the second UE via the third communication link, a report comprising the channel information associated with the second communication link; and
relay, via the transceiver, to the first transmission and reception point via the first communication link, the report comprising the channel information associated with the second communication link.

30. The apparatus of claim 29, wherein:
to receive the request for the channel information associated with the second communication link, the memory and the processor are configured to cause the apparatus to receive, via the transceiver, a first medium access control control element, the first medium access control control element comprising the request for the channel information associated with the second communication link; and
to transmit the report comprising the channel information associated with the second communication link, the memory and the processor are configured to cause the apparatus to transmit, via the transceiver, a second medium access control control element, the second medium access control control element comprising the report comprising the channel information associated with the second communication link.
